(19) United States
(12) Patent Application Publication
(10) Pub. No.: US 2022/0167023 A1
(43) Pub. Date: May 26, 2022

(54) INFORMATION PROCESSING APPARATUS, INFORMATION PROCESSING METHOD, AND PROGRAM

(71) Applicant: SONY GROUP CORPORATION, Tokyo (JP)

(72) Inventors: Yasuaki YAMAGISHI, Kanagawa (JP); Kazuhiko TAKABAYASHI, Tokyo (JP)

(73) Assignee: SONY GROUP CORPORATION, Tokyo (JP)

(21) Appl. No.: 17/439,678

(22) PCT Filed: Mar. 6, 2020
(86) PCT No.: PCT/JP2020/009657

§ 371 Date: Sep. 15, 2021

(30) Foreign Application Priority Data
Mar. 22, 2019 (JP) 2019-055387

(51) Int. Cl. H04N 21/234; H04N 21/238; H04N 21/242

(52) U.S. Cl. CPC H04N 21/234; H04N 21/242; H04N 21/238

(57) ABSTRACT

The present disclosure relates to an information processing apparatus, an information processing method, and a program capable of providing seamless streaming. An optimization segment from contents multicast is generated from a distribution server when optimization processing is performed on a segment corresponding to a request by a client terminal according to a viewpoint direction in the client terminal, and the optimization segment is transmitted to the client terminal. The present technology can be applied to, for example, an information processing system that provides seamless streaming.

### TECHNICAL FIELD

The present disclosure relates to an information processing apparatus, an information processing method, and a program, and more particularly, to an information processing apparatus, an information processing method, and a program capable of providing seamless streaming.

### BACKGROUND ART

In recent years, there is a concern about an increase in a processing load of a cloud due to streaming viewing by a mobile device which has become widespread at an extraordinarily high speed. In response to such a concern, the load distribution of a streaming service using edge computing by network resources dispersedly arranged at an edge portion of a network, calculation resources, storage resources, or the like attracts attention as one of measures for alleviating the processing load of the cloud.

For example, in the edge computing, there is a limit that various resources of individual edge servers are smaller than that of a central cloud. Therefore, the arrangement, selection, and the like of resources become complicated, and there is also that disadvantage that a management cost increases. On the other hand, in the future, as the spread of streaming services of high-quality contents such as so-called 4K or 8K is further expanded, it is considered that a mechanism for realizing efficient operation of such edge computing resources is required.

For example, there is a technology of distributing contents using MPEG-dynamic adaptive streaming over HTTP (DASH) disclosed in Non-Patent Document 1.

### CITATION LIST

### Patent Document

Non-Patent Document 1: ISO/IEC 23009-1:2012 Information technology Dynamic adaptive streaming over HTTP (DASH)

### SUMMARY OF THE INVENTION

### Problems to be Solved by the Invention

Incidentally, during streaming viewing on a mobile device, a handover (hereinafter, referred to as an inter-base station handover) occurs in which the device moves and transitions cells across base stations. When such an inter-base station handover occurs (that is, when a MEC environment to be described later transitions), a use case is assumed in which a MEC environment of a transition destination cell, for example, the number of clients included in the cell and an execution state of a service group providing a service to the client group are different.

Therefore, even in a use case in which such an inter-base station handover occurs, it is required that a virtual reality (VR) stream personalized to the client is not interrupted, and seamless streaming can be performed. Here, the seamless streaming means that the streaming is continued without interruption even in the case of moving across cells.

The present disclosure has been made in view of such a situation, and an object thereof is to provide seamless streaming in a use case accompanied by occurrence of an inter-base station handover.

### Solutions to Problems

An information processing apparatus according to one aspect of the present disclosure includes: an optimization processing unit that generates an optimization segment from contents multicast from a distribution server by performing optimization processing on a segment corresponding to a request by a client terminal according to a viewpoint direction in the client terminal; and a transmission unit that transmits the optimization segment to the client terminal.

An information processing method or a program according to one aspect of the present disclosure includes: generating an optimization segment from contents multicast from a distribution server by performing optimization processing on a segment corresponding to a request by a client terminal according to a viewpoint direction in the client terminal; and transmitting the optimization segment to the client terminal.

In one aspect of the present disclosure, an optimization segment from contents multicast is generated from a distribution server by performing optimization processing on a segment corresponding to a request by a client terminal according to a viewpoint direction in the client terminal, and the optimization segment is transmitted to the client terminal.

### BRIEF DESCRIPTION OF DRAWINGS

FIG. 1 is a diagram for explaining VDO in a known general server.

FIG. 2 is a diagram illustrating a configuration example of an embodiment of an information processing system to which the present technology is applied.

FIG. 3 is a diagram illustrating a configuration example of a 5G core network system function group and an ME-host.

FIG. 4 is a diagram for explaining VDO activation, push streaming, and VDO processing.

FIG. 5 is a diagram illustrating a first configuration example of a streaming stack.

FIG. 6 is a diagram illustrating a second configuration example of the streaming stack.

FIG. 7 is a diagram illustrating a third configuration example of the streaming stack.

FIG. 8 is a diagram for explaining a viewport in a DASH-client.

FIG. 9 is a diagram illustrating an example of viewport metrics and viewport data type.

FIG. 10 is a diagram illustrating an example of MPD and the VM.

FIG. 11 is a flowchart for explaining a process of distributing a segment subjected to the VDO processing.

FIG. 12 is a diagram illustrating a description example of workflow description.

FIG. 13 is a diagram illustrating another description example of the workflow description.

FIG. 14 is a diagram for explaining an application object.

FIG. 15 is a diagram for explaining application activation by a workflow manager.

FIG. 16 is a flowchart for explaining application activation processing.

FIG. 17 is a diagram for explaining view metrics notification and VDO segment generation processing.

FIG. 18 is a diagram for explaining VDO transition due to an inter-base station handover.

FIG. 19 is a diagram illustrating movement of the DASH-client from a source RAN to a target RAN.

FIG. 20 is a diagram illustrating a description example of KeepAlreadyEstablishedIfFailed.

FIG. 21 is a diagram illustrating a description example of DoNotMigrate.

FIG. 22 is a diagram for explaining a process of transitioning VDO between ME-hosts.

FIG. 23 is a flowchart for explaining VDO transition processing by the inter-base station handover.

FIG. 24 is a diagram for explaining a case where VDO cannot be activated on an ME-host serving as a transition destination due to a resource shortage.

FIG. 25 is a diagram illustrating movement of the DASH-client from the source RAN to the target RAN.

FIG. 26 is a diagram for explaining processing in a case where VDO cannot be activated on the ME-host serving as the transition destination due to the resource shortage.

FIG. 27 is a diagram for explaining a case where a transition destination cell cannot be predicted.

FIG. 28 is a diagram illustrating movement of the DASH-client from the source RAN to a target RAN-A.

FIG. 29 is a diagram for explaining processing in a case where the transition destination cell cannot be predicted.

FIG. 30 is a diagram for explaining a process of securing a fault tolerance redundancy.

FIG. 31 is a diagram illustrating movement of the DASH-client from the source RAN to a target RAN-A and a target RAN-B.

FIG. 32 is a diagram for explaining a process of securing the fault tolerance redundancy.

FIG. 33 is a diagram illustrating a description example of workflow description.

FIG. 34 is a diagram for explaining variable duplication of the state of the VDO processing based on traffic prediction.

FIG. 35 is a flowchart for explaining a process of variably duplicating the state of the VDO processing based on traffic prediction.

FIG. 36 is a diagram for explaining a flow of segments when the VDO processing is performed with a synchronous adaptation VDO processing request as a trigger.

FIG. 37 is a diagram illustrating a description example of a VDO trigger request.

FIG. 38 is a diagram illustrating another description example of the VDO trigger request.

FIG. 39 is a diagram for explaining the VDO processing in an edge server.

FIG. 40 is a block diagram illustrating a configuration example of an embodiment of a computer to which the present technology is applied.

### MODE FOR CARRYING OUT THE INVENTION

Hereinafter, specific embodiments to which the present technology is applied will be described in detail with reference to the drawings.

<VDO Processing in Known General Server>

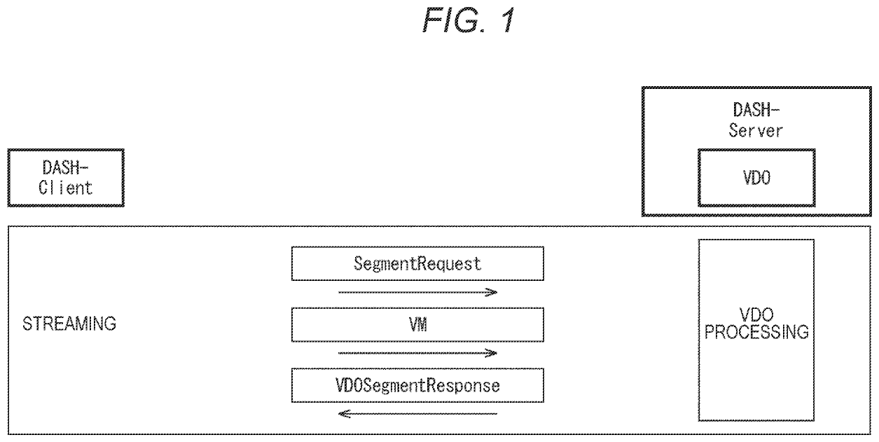

First, before describing an information processing system to which the present technology is applied, viewport dependent optimizer (VDO) processing in a known general server will be described with reference to FIG. 1.

As illustrated in FIG. 1, generally, a DASH-client issues a segment request for requesting acquisition of a DASH-segment to a DASH-server. Then, in response to reception of the segment request, the DASH-server activates a VDO application (hereinafter, also simply referred to as a VDO) which executes the VDO processing.

At this time, one DASH-server performs processing corresponding to segment requests from a plurality of DASH-clients. Therefore, separately from the segment request received from each DASH-client, the VDO generates the DASH-segment subjected to the VDO processing on the basis of the contents of viewport metrics (VM) of the notification given by each DASH-client and returns a response (VDO segment response) to the segment request.

Incidentally, in general, the segment request and the VM are separately sent from the DASH-client. Therefore, in a case where the interval of the notification frequency at which the notification of the VM is given is longer than a segment length, particularly, in a case where the granularity of the segment is fine, there is a possibility that it is difficult to associate the switching timing of the VM with a VDO target segment. On the other hand, when the interval of the notification frequency of the VM is shortened, it is assumed that the data amount of the VM becomes a burden of the traffic.

<Use Case>

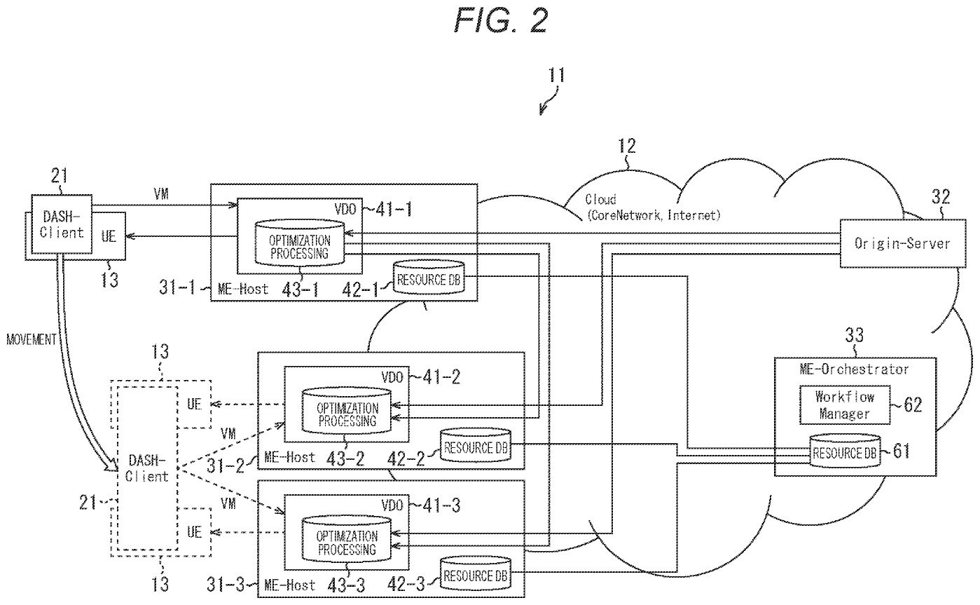

FIG. 2 is a diagram for explaining a use case in which use of an information processing system to which the present technology is applied is assumed.

In the configuration example illustrated in FIG. 2, the information processing system 11 includes a cloud 12 and a user terminal 13.

The cloud 12 is configured by connecting a plurality of servers via a network, and each server executes processing to provide various services. For example, in the information processing system 11, the cloud 12 can provide a streaming service of distributing VR contents to the user terminal 13.

As illustrated, the cloud 12 has a configuration in which ME-hosts 31-1 to 31-3, an origin-server 32, and a ME-platform (orchestrator) 33 are connected via a network. Note that the ME-hosts 31-1 to 31-3 are similarly configured and are simply referred to as the ME-host 31 in a case where it is not necessary to distinguish them, and each block configuring the ME-host 31 is also referred to similarly. Then, the ME-host 31 includes a VDO 41 and a database holding unit 42, and the VDO 41 includes a storage unit 43. Furthermore, the ME-platform (orchestrator) 33 includes a database holding unit 61 and a workflow manager 62.

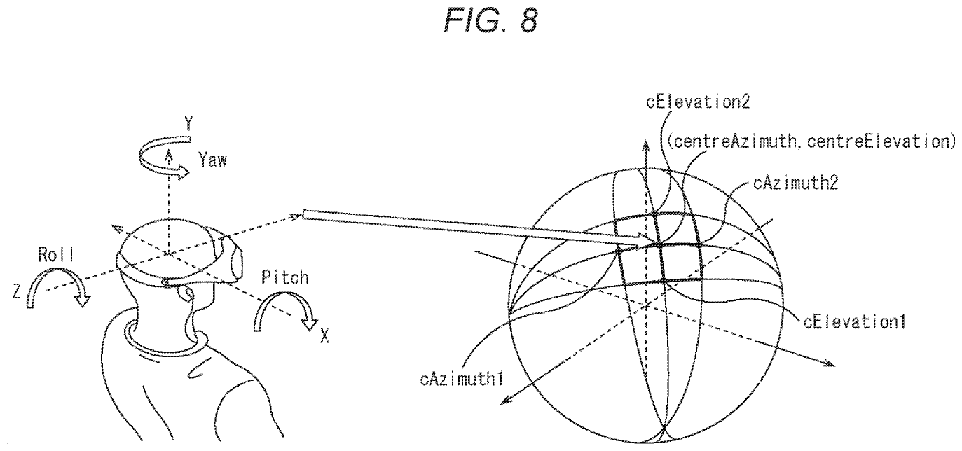

For example, a smartphone, a head mounted display as illustrated in FIG. 8, or the like can be used as the user terminal 13, and the user terminal can receive and display the VR contents distributed by a streaming service from the cloud 12. For example, the user terminal 13 has a configuration in which a DASH-client 21 is mounted.

Then, a 5G-multi-access edge computing (MEC) architecture is assumed as a network that can be used in such a use case in the future.

Specifically, first, in a case where DASH is used as a streaming protocol, the DASH-client 21 mounted on the user terminal (UE: User Equipment) 13 is connected to a VDO 41-1 on the ME-host 31-1. Then, the VDO 41 is connected to the general origin-server 32 which is a root server of DASH streaming. For example, a multistage hierarchy may be configured from the VDO 41 to the origin-server 32 similarly to a general contents delivery network (CDN) server configuration.

The DASH-client 21 is a streaming reception/reproduction application executed on the user terminal 13 which receives a stream.

The VDO 41 is a streaming transmission application executed on the ME-host 31 which transmits streaming to the DASH-client 21. Furthermore, the VDO 41 has a function of optimizing DASH streaming, and has a function of exchanging information necessary for the optimization with the DASH-client 21. For example, the VDO 41 has a function of performing viewport dependent (VD) optimization which is one use case of optimization.

For example, as one method of the VD optimization by the VDO 41, there is a method of generating a DASH-segment (viewport dependent optimized segment) configured by the viewport dependent packed picture (the image processed by region wise packing) optimized in the line-of-sight direction of the user in the DASH-client 21. Here, the optimization in the line-of-sight direction of the user is, for example, to increase the information amount or high definition of the image in the line-of-sight direction of the user.

Incidentally, in a case where the transition of the MEC environment occurs along with an inter-base station handover due to movement of the user terminal 13, it is required to enable seamless streaming regardless of the transition of the MEC environment as much as possible before and after the inter-base station handover. Then, as a scheme for securing the seamless streaming, a method is considered in which the VDO 41-1 executed in the ME-host 31-1 (MEC environment) bound to the cell before the transition is also simultaneously transitioned to the ME-host 31-2 or 31-3 bound to the cell after the transition. Specifically, the VDO application executed in the MEC environment before the transition is executed in the MEC environment after the transition, so that an execution state in the MEC environment before the transition is reproduced and duplicated in the MEC environment after the transition.

Then, when this method is realized, it is possible to obtain an effect that streaming can be made seamless by grasping the network traffic of the cell of the transition destination or the load status of the resource on the ME-host 31 and then duplicating the execution state on the ME-host 31-1 before the transition on the ME-host 31-2 or 31-3 of the transition destination before the inter-base station handover occurs.

In this manner, by transitioning the VDO 41-1 of the ME-host 31-1 to the VDO 41-2 of the ME-host 31-2 or the VDO 41-3 of the ME-host 31-3 bound to the cell after the movement of the user terminal 13, the information processing system 11 can maximize the advantages of MEC computing such as low delay and load distribution.

Incidentally, in the MEC architecture including a conventional standard interface, protocol, and the like, such a use case is not supported, and thus seamless streaming is not realized. That is, a MEC architecture which can be mounted on mobile network capture devices with different vendors and models, a MEC architecture which supports such services in a cloud environment, or the like is not present.

In this regard, as described below, in this embodiment, a standard protocol (application programming interface (API)) and a flow (sequence) used in the MEC architecture necessary for realizing seamless streaming by performing duplication (process duplication) of the execution state as described above are newly proposed.

Here, contents which are known techniques will be described.

First, it is a known technology that an application migrates (transitions) on the ME-host 31, for example, when the user terminal 14 performs handover between the ME-host 31-1 and the ME-host 31-2. On the other hand, the runtime (execution) resource negotiation of the migration destination is not defined as a standard protocol.

Furthermore, in the European telecommunications standards institute (ETSI), it is a known technology that registers execution conditions (such as a static memory and a disk upper limit) of a general application in the ME-platform. On the other hand, a specific means for realizing such registration is not yet discussed.

Here, contents newly proposed in the present disclosure will be further described.

First, in the ME-host 31-1 in the vicinity of the user terminal 13, the VDO 41-1 connected to the DASH-client 21 on the user terminal 13 is executed. Then, a protocol for performing state synchronization between the VDO 41-1 and the VDO 41-2 on the ME-host 31-2 or the VDO 41-3 on the ME-host 31-3 bound to the transition destination base station in which the inter-base station handover of the user terminal 13 is predicted is newly proposed.

Moreover, there is proposed a method of attaching the VM to the segment request to be subjected to the VDO processing, in particular, a method of coping with a case where it is necessary to secure the synchronization accuracy between the segment and the VM when it is assumed that the granularity of the Segment is fine.

In this regard, in this embodiment, as described below, a CPU for operating the VDO 41-2 or 41-3 or resources for securing a storage area, an input/output (IO) throughput, and the like are reserved on the ME-host 31-2 or 31-3 of the transition destination cell. Thereafter, the VDO processing state based on the VM (the state information of the user terminal 13), which is acquired by the VDO 41-1 before the transition, from the individual DASH-client 21 establishing the streaming session is duplicated. That is, the process optimized for the DASH-client 21 executed by the VDO 41-1 before transition is duplicated on the ME-host 31-2 or 31-3 of the cell of the predicted transition destination. At this time, state synchronization is continued until the transition is completed. The processing state synchronization includes, for example, the VDO segment generated by performing the VDO processing and the state information of the user terminal 13 already acquired.

Furthermore, in this processing state synchronization, there are a case where exactly the same process as the VDO processing performed by the VDO 41-1 before the transition is performed by the VDO 41-2 or 41-3 and a case where the state synchronization is performed to be optimized for the environment of the transition (scheduled) destination.

For example, in a case where the state synchronization is performed to be optimized for the environment of the transition (scheduled) destination, the streaming quality in the environment of the transition destination is changed to a streaming quality different from the streaming quality before the transition. This change in the streaming quality is performed on the basis of the traffic information of the transition destination cell acquired by the VDO 41-2 or 41-3 executed in the transition (scheduled) destination ME-host 31-2 or 31-3 via the API for acquiring the ME environment information of the transition destination mounted in the transition destination ME-host 31-2 or 31-3 or the load information of the transition destination ME-host 31-2 or 31-3. Alternatively, the change in the streaming quality is performed on the basis of a variation prediction in the near future from the current environment information.

For example, in a case where the streaming quality can be changed within a range of this limit, the streaming quality is changed within the range of the limit. Note that, in a case where the streaming quality cannot be changed within the range of this limit, the processing of the transition source VDO 41-1 is maintained even after the transition of the user terminal 13, and the request for generation of the necessary VDO segmen is redirected from the transition destination ME-host 31-2 or 31-3 to the transition source ME-host 31-1.

Moreover, in a case where there are two or more transition destination cells (ME-host environment) simultaneously, that is, in a case where there is a hierarchical relationship between the coverages, in a case where there is a cell boundary (ME-host environment boundary), or in a case where the transition destination cell (ME-host environment) cannot be predicted, the VDO 41 is simultaneously executed in the ME-hosts 31 of the plurality of transition destination cells to perform processing synchronization, or the VDO 41 is executed in the ME-host 31 of the cell with a better environment to perform processing synchronization.

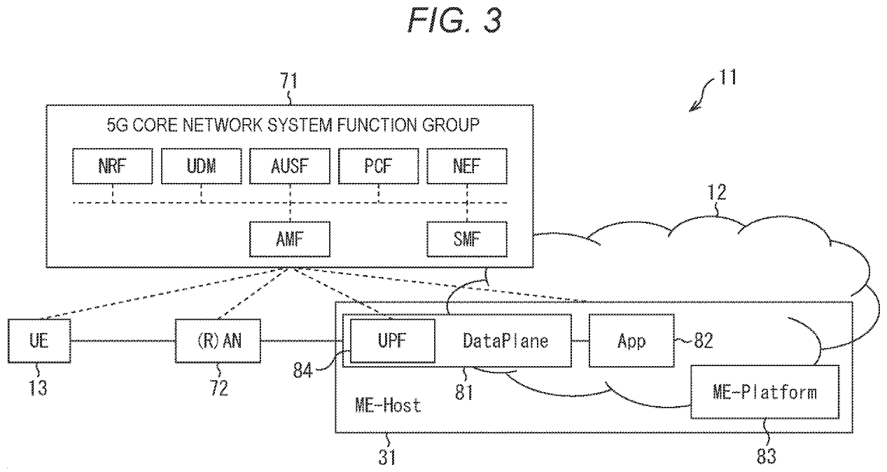

Here, a 5G core network system function group 71 in the information processing system 11 of this embodiment and a session between the user terminal 13 and the application 82 in the ME-host 31 which is the MEC environment will be described with reference to FIG. 3.

For example, in the information processing system 11, an edge server in edge computing can significantly improve a communication delay which is one of bottlenecks in conventional cloud computing. Moreover, by executing distribution processing of a high-load application among the user terminal 13, the ME-host 31 as an edge server, and the origin-server 32 as a cloud server, it is possible to speed up processing.

Note that the standard specification of the edge computing is defined in “ETSI-MEC”. Then, the ME-host in the ETSI-MEC corresponds to the ME-host 31 which is the edge server.

In the example illustrated in FIG. 3, a line connecting the application 82 on the ME-host 31 and the user terminal 13 (the application mounted above) via the access network 72 of the 5G core network system function group 71 standardized by the third generation partnership project (3GPP) represents a user data session. Note that the access network ((R) AN) 72 in the 5G core network system function group 71 includes a wired access network (AN) and a radio access network (RAN).

Furthermore, there is an edge computing platform called a ME-platform 83 on the ME-host 31. Then, the application 82 executed by the ME-platform 83 exchanges user data such as stream data with the user terminal 13 via the data plane 81 which is an abstraction of a user data session with the user terminal 13. Here, the data plane 81 has a function as a user plane function (UPF) 84 of 3GPP. Note that the data plane 81 may have a function corresponding to the UPF 84.

Furthermore, in the 5G (5th generation mobile communication system) core network system function group 71, a service-based architecture is adopted, and a plurality of network functions (NF) which are functions of a core network is defined. Then, these NFs are connected via a unified interface called a service-based interface.

In the example of FIG. 3, an NF repository function (NRF: the service discovery of NF), unified data management (UDM: the management of subscriber information), an authentication server function (AUSF: the management of authentication information of UE), a policy control function (PCF: the control of policy regarding mobility and session management for a proper operation of AMF and SMF), a network exposure function (NEF: the provision of an NF service to an application in an MNO network), an access and mobility management function (AMF: mobility management/authentication/authorization of the UE, the control of SMF), and a session management function (SMF: the session management of UE) are illustrated as the NFs.

<First Information Processing Example of Information Processing System>

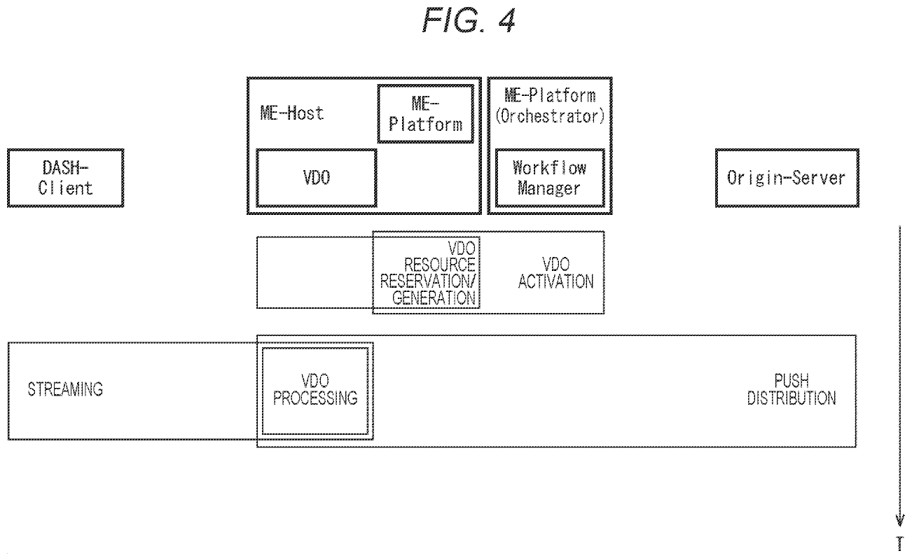

A multicast and VDO processing in an edge server will be described as a first information processing example of the information processing system 11 with reference to FIGS. 4 to 17.

FIG. 4 is a diagram for explaining the activation of the VDO 41 by the workflow manager 62, and push streaming and the VDO processing.

For example, in the information processing system 11, the VDO application executed on the ME-host 31 is activated by the workflow manager 62 mounted as an application on the ME-platform (orchestrator) 33.

First, on the basis of workflow description describing network resources, calculation resources, storage resources, and the like required for execution of the VDO application to be activated, the workflow manager 62 secures necessary resources via the API of the ME-platform 83 and activates the target application (VDO activation and VDO resource reservation/generation in FIG. 4).

Thereafter, the DASH-client 21 first finds the VDO 41 on the nearby ME-host 31 and issues a segment request for requesting acquisition of the DASH-segment to the VDO 41. At this time, it is assumed that the origin-server 32 performs multicast push distribution of the DASH-segment (or a baseband stream before encoding as described later) to the VDO 41 (push distribution in FIG. 4).

On the other hand, the VDO 41 receives the VM for every DASH-client 21 from a plurality of DASH-clients 21. Note that any notification method may be used for transmission and reception of the VM, and for example, the metrics notification of server and network-assisted DASH (SAND) can be used.

Here, in this embodiment, as a notification method that cannot be handled by the metrics notification of the SAND, it is newly proposed to apply the URL parameter (23009-1:Annex.I. Flexible Insertion of URL Parameters) defined in the DASH to the notification method of the VM such that the segment to be optimized can be clearly indicated. Note that, in addition to this, for example, a method may be considered which performs storing in the header of the HTTP request of the Segment and passing.

Then, on the basis of the received contents of the VM, the VDO 41 performs the VDO processing on the DASH-segment (or a baseband stream) push-distributed from the origin-server 32. For example, in the VDO processing, the DASH-segment distributed from the origin-server 32 is once decoded (as it is in the case of the baseband stream), and the image quality and the resolution in a viewpoint direction are increased by region-wise packing or the like, and the encoded data is re-encoded to generate the VDO segment (the DASH-segment subjected to the VDO processing).

Here, a configuration example of the streaming stack will be described.

For example, the origin-server 32 multicasts the DASH-segment as the push distribution to the VDO 41 in some cases, and multicasts the baseband stream before encoding in other cases. That is, the origin-server 32 simultaneously broadcasts the same segment or baseband stream file to the VDOs 41 on all the ME-hosts 31 connected to the cloud 12 using, for example, a file multicast protocol such as FLUTE (ROUTE) or the like.

The push distribution by the multicast is used, for example, in a case where a variation in the quality (for example, a bit rate or the like) of the request from the DASH-client 21 cannot be predicted in advance on the sending side. On the other hand, in a case where a variation in the quality of the request can be assumed in advance, a plurality of representations having different qualities is encoded and prepared on the basis of a certain adaptation set.

Furthermore, in the use case of VR streaming, there is a case of preparing a variation in which the image quality is optimized depending on the viewpoint direction (viewport) of the end user. In this case, in order to accurately follow the viewpoint movement of the user, it is necessary to prepare a large number of optimized segment variations in all viewpoint directions, and thus there is a possibility that server resources and network resources are wasted more than necessary.

Therefore, on the origin-server 32 side, in a case where the quality of the segment requested from the DASH-client 21, the transition locus of the viewport, and the like cannot be assumed, for example, one representation is arranged in a certain adaptation set, and one segment (a segment with the highest quality, for example, a segment which is all configured with I frames) which is not subjected to the VDO processing and has a uniform image quality in the entire viewing angle direction is arranged therein. Then, it is preferable to adopt a method in which this one type of segment is multicast-distributed from the origin-server 32 to all the ME-hosts 31, and in the ME-host 31 at an edge close to the DASH-client 21, the DASH-segment (VDO segment) subjected to the VDO processing is generated on the basis of the notified viewpoint direction information in the VM obtained from the individual DASH-client 21 one by one. That is, by adopting this method, it is assumed that it is possible to avoid wasteful consumption of distribution resources.

Note that the quality of the segments to be multicast is encoded (compressed) at the highest quality in some cases or is transmitted as a baseband stream without encoding in other cases. For example, even in a baseband broadband stream, it may be possible to sufficiently save distribution resources by using a multicast protocol as compared with a bidirectional protocol such as HTTP/TCP.

Furthermore, in addition to arranging one representation in the adaptation set, a case of preparing a segment of image quality (alternatively, there may be variations such as image quality which is uniform in an azimuth angle direction and image quality which is non-uniform in an altitude angle direction) that is uniform in the entire viewing angle direction by being divided in advance into a plurality of bit rates and the like are also considered.

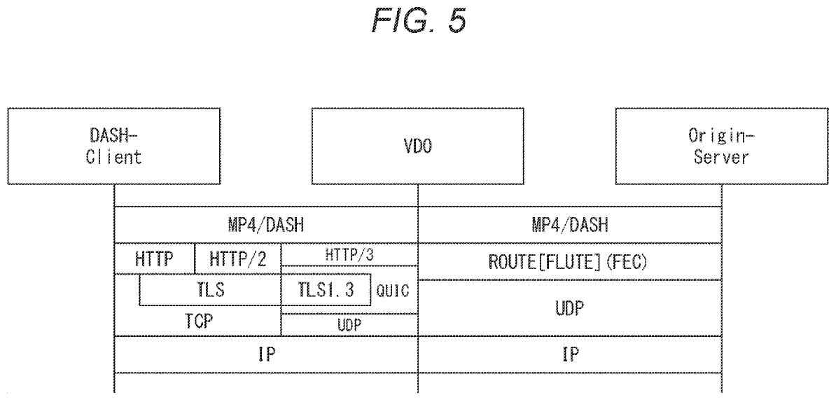

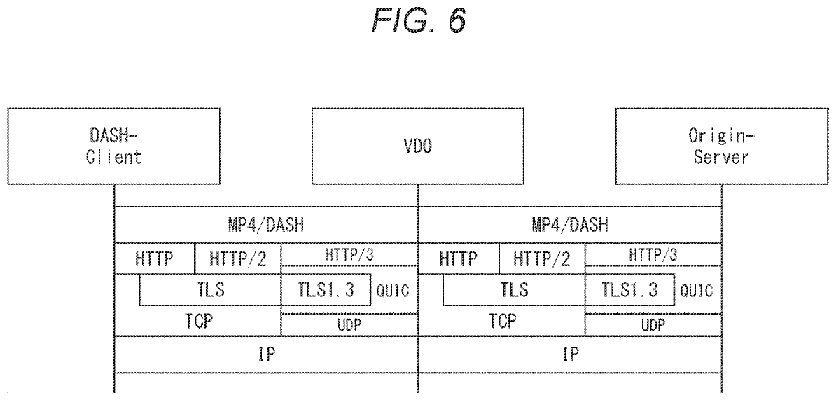

FIGS. 5 and 6 illustrate a configuration example of a streaming stack between the DASH-client 21, the VDO 41, and the origin-server 32.

For example, FIG. 5 illustrates a first configuration example of a streaming stack in which unidirectional multicasting is performed from the origin-server 32 to the VDO 41 so as to perform simultaneous broadcasting by the push distribution, and streaming having the same contents is distributed to all VDOs 41.

Furthermore, FIG. 6 illustrates a second configuration example of a streaming stack in which an acquisition request is issued from the VDO 41 side, and streaming is acquired from the origin-server 32 in bidirectional unicast although it appears like the push distribution as a whole. For example, in the second configuration example of the streaming stack, the VDO 41 side grasps the tendency of the request from the subordinate DASH-client 21, and can distribute the streaming to preferentially allocate the distribution resource to the segment in which the higher resolution is made in the viewpoint direction having a relatively high possibility of being accessed. That is, in the second configuration example of the streaming stack, it is possible to realize the distribution according to the tendency of the request from the DASH-client 21 instead of the push distribution which becomes perfect simultaneous broadcast.

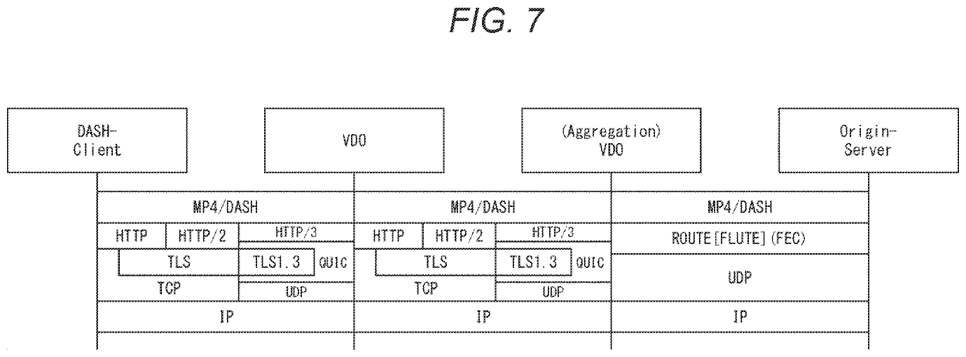

FIG. 7 illustrates a third configuration example of a streaming stack in which an aggregation VDO obtained by bundling a plurality of VDOs 41 is configured in multiple stages. For example, the aggregation VDO is executed in a certain ME-host 31 configuring the cloud 12.

For example, in the third configuration example of the streaming stack, from the origin-server 32 to the aggregation VDO, the same contents are distributed to all the aggregation VDOs by unidirectional multicast to perform simultaneous broadcasting in a push type. Then, in the individual aggregation VDO, the tendency of the request from the DASH-client 21 to be handled by its own subordinate VDO 41 is grasped in a hierarchically intensive manner, and it is possible to distribute the streaming to preferentially allocate the distribution resource to the segment which has the higher resolution in the viewpoint direction having a relatively high possibility of being accessed. That is, also in the third configuration example of the streaming stack, it is possible to realize the distribution according to the tendency of the request from the DASH-client 21 instead of the push distribution which becomes perfect simultaneous broadcast.

Here, a method of sending the VM will be described.

For example, the viewport in the DASH-client 21 is specified by the X axis, the Y axis, and the Z axis as illustrated in FIG. 8, and pitch rotation, yaw rotation, and roll rotation about these axes. At this time, assuming that the body of the end user is fixed, the angle is determined according to the motion of the head of the end user. For example, the angles of the pitch rotation, the yaw rotation, and the roll rotation increase in the clockwise direction toward the positive direction of each of the X axis, the Y axis, and the Z axis. Furthermore, the X-Z plane is parallel to the ground, and it is defined that all angles are zero when the positive direction of the Z axis is viewed. Then, mapping is performed from the coordinate system of the viewport metadata to the coordinate system of the stream source.

For example, it is assumed that the coordinate system in the source uses an expression method using an azimuth angle and an altitude angle, and the client side uses a coordinate system expressed by the pitch rotation, the yaw rotation, and the roll rotation. In this case, mapping is performed such that the direction in which both the azimuth angle and the altitude angle (center azimuth/center elevation) of the source coordinate system are zero coincides with the direction in which all of the pitch rotation, the yaw rotation, and the roll rotation in the DASH-client 21 are zero. Then, the viewport coordinate values in the converted coordinate system are stored in the rendered viewport metrics of 23090-6: Immersive Media Metrics, which is under consideration at the time of filing of the present application, along the structure SphereRegionStruct defined in an omnidirectional media application format (OMAF), and are set as the VM.

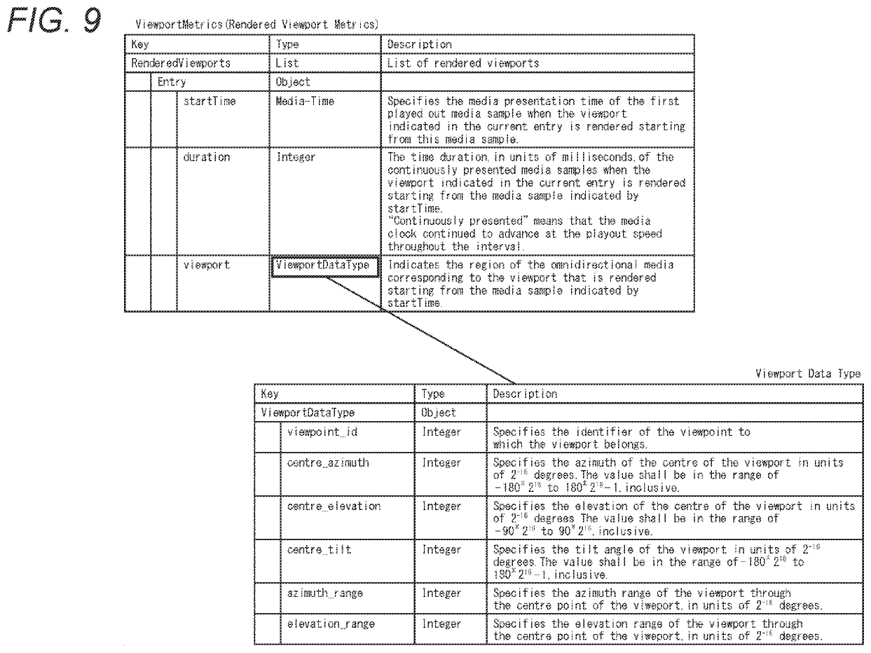

FIG. 9 illustrates an example of viewport metrics (rendered viewport metrics) and viewport data type.

For example, as an example of a method of sending the VM to the VDO 41, there is a method of using the URL parameter (23009-1: Annex.I. Flexible Insertion of URL Parameters) defined in DASH. Note that the application of the URL parameter of the DASH to the VM transmission is newly proposed in the present disclosure.

Furthermore, the URL parameter of the DASH inserts a query character string into the segment URL of the segment request, and the information of the DASH-client 21 specified on the server side can be stored in the query character string. Here, the DASH-client 21 is notified of the type of information to be stored in the query character string by media presentation description (MPD).

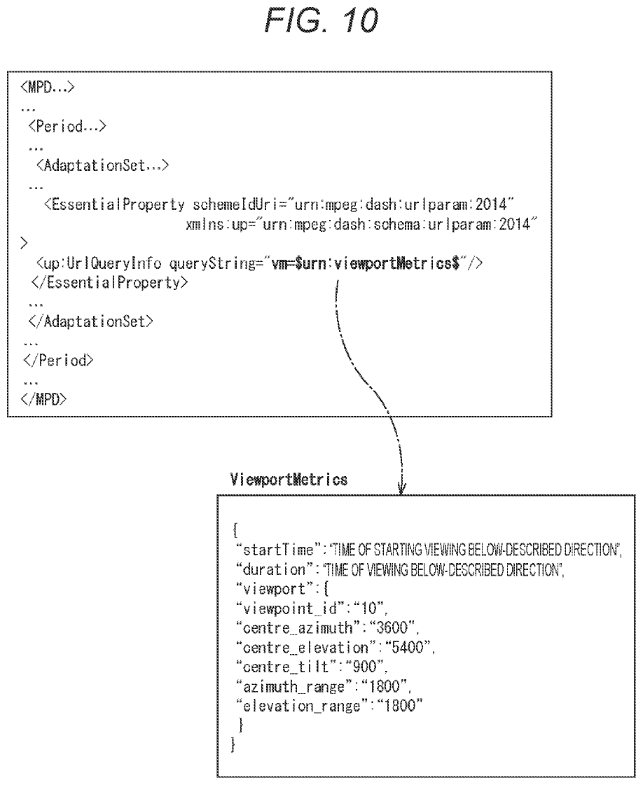

FIG. 10 illustrates an example of the MPD and the VM applied to the notification of the VM proposed in this embodiment.

As illustrated in FIG. 10, the MPD includes an adaptation set which addresses a VR stream to be reproduced. Then, urn specifying the data structure of the VM to be added as the query character string of the segment URL used when requesting the segment of the VR stream is stored as a value of the attribute queryString of the URL query info element defined by the XML namespace “urn:mpeg:dash:schema:urlparam:2014” under the subordinate essential property element of the adaptation set. For example, in the example illustrated in FIG. 10, the data structure of the JSON instance starting from the lower right field “startTime” is specified as the data structure of the VM, and “urn:viewportMetrics” is stored as the urn specifying the data structure of the VM. Therefore, the DASH-client 21 can give an instruction to add the VM to the segment request and send the segment request.

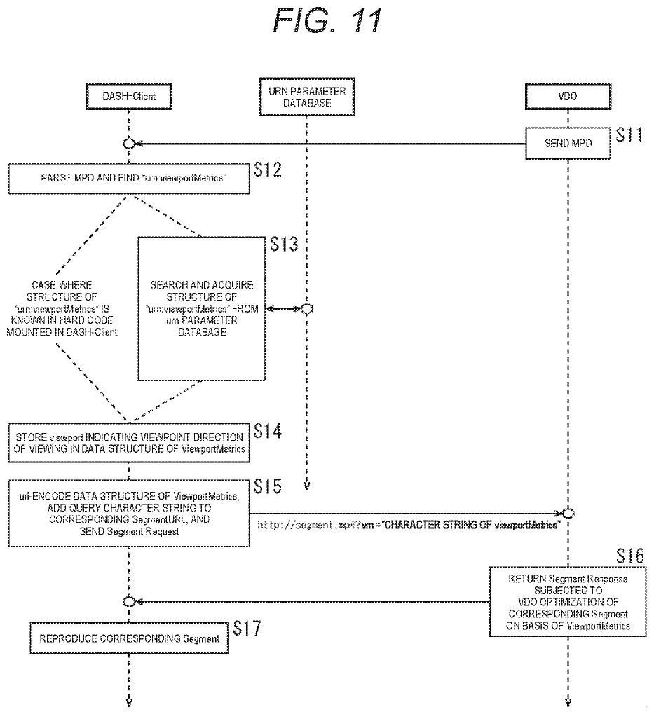

FIG. 11 is a flowchart for explaining a process of distributing the segment subjected to the VDO processing by the VDO 41.

In step S11, the VDO 41 sends the MPD illustrated in FIG. 10 to the DASH-client 21. Therefore, the DASH-client 21 receives the MPD.

In step S12, the DASH-client 21 parses the MPD sent in step S11 and finds “urn:viewportMetrics”.

Then, in a case where the structure of “urn:viewportMetrics” is unknown in the hard code mounted in the DASH-client 21, the processing proceeds to step S13. In step S13, the DASH-client 21 searches and acquires the structure of “urn:viewportMetrics” from the urn parameter database, and then the processing proceeds to step S14.

On the other hand, in a case where the structure of “urn:viewportMetrics” is known in the hard code mounted in the DASH-client 21, the processing skips step S13 and proceeds to step S14.

In step S14, the DASH-client 21 stores a viewport indicating a viewpoint direction of viewing in the data structure of the VM.

In step S15, the DASH-client 21 URL-encodes the data structure of the VM, adds a query character string to the segment URL, and sends the segment request to the VDO 41. Therefore, the VDO 41 receives the segment request.

In step S16, the VDO 41 returns the segment response optimized by performing the VDO processing on the segment on the basis of the VM sent in step S15. Therefore, the DASH-client 21 receives the segment response.

In step S17, the DASH-client 21 reproduces the segment subjected to the VDO processing on the basis of the segment response returned in step S16. Then, similarly, the sending of the segment request and the return of the segment response are repeatedly performed.

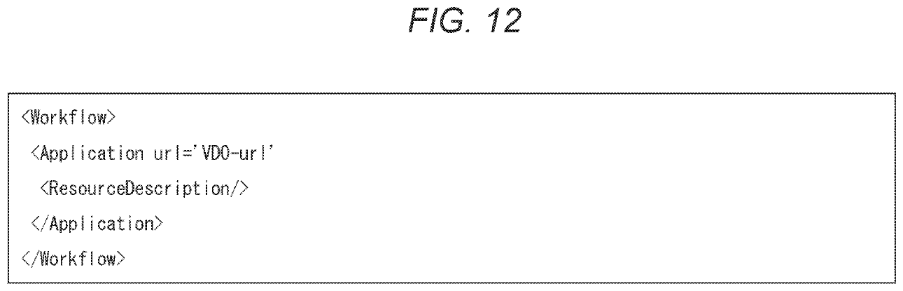

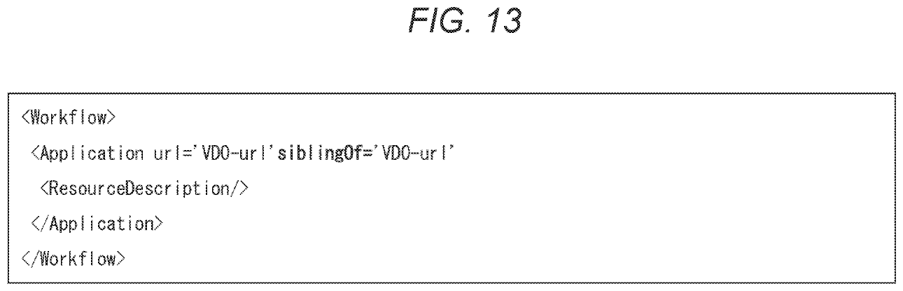

FIGS. 12 and 13 illustrate an example of uniquely defined workflow description newly proposed in the present disclosure. Here, although it is uniquely defined, the workflow of the media processing on the cloud and the framework of the application are currently under specification development by MPEG-I-network-based media processing (NBMP), and the specification is not determined. Note that only VDO is described in this workflow description.

As illustrated in FIG. 12, an element immediately below the Workfflow element is an application element having a URL attribute value ‘VDO-url’ and represents execution of the VDO application. Furthermore, in the resource description element, a resource necessary for executing the VDO application is described.

Here, there is no input/output connection between applications. Furthermore, the stream file (for example, a DASH-segment file) processed and provided by the VDO 41 is acquired by accessing another application as a proxy server or is provided by being accessed from another application in a file access method (for example, HTTP) provided by a web server on which the VDO 41 is mounted.

Note that, as in the VDO 41 and the aggregation VDO illustrated in the configuration example of the streaming stack in FIG. 7 described above, a hierarchy can be configured between the VDOs 41. Therefore, there may be a case where the stream file is first processed by the VDO 41 of the upper layer and thereafter transferred to the VDO 41 subordinate thereto or is processed by the subordinate VDO 41 without being processed by the VDO 41 of the upper layer.

In this regard, in the workflow description illustrated in FIG. 13, a siblingOf attribute is newly introduced so that such a hierarchical relationship of processing between applications can be defined. Therefore, it is represented that the VDO applications can be positioned under different VDO instances.

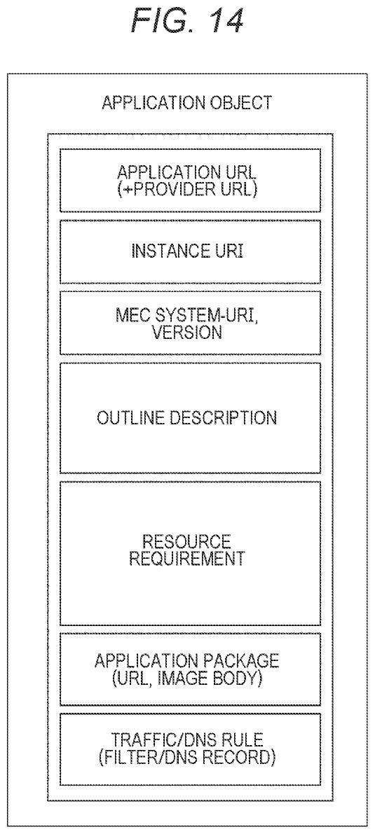

FIG. 14 illustrates an example of an application object representing an application attribute of the VDO application as described above. For example, the attribute definition of the application object is managed by the ME-platform, and the individual attribute of each application is managed on the basis of the attribute definition.

In an application URL (+provider URL), the type of the application of the VDO or the like is identified (a provider URL is also identified in +option). For example, it is specified by Application@url described in the workflow description.

An instance URI identifies the application at the time of executing the application, and is generated by the ME-platform at the time of executing the application.

A MEC system-URI, version is an identifier that identifies an MEC system (virtual environment) in which the application is executed.

An outline description describes the outline of the processing of the application.

A resource requirement includes the specification of numerical values such as virtual CPU usage/second+period, virtual memory/storage capacity/second+period, IO throughput/second+period, and the like, and are defined by an MEC system URL-dependent resource class ID. For example, it is specified by the resource description described in the workflow description.

An application package (URL, image body) is the URL of an MEC system-dependent application execution image or the image body thereof.

A traffic/DNS rule (filter/DNS record) is information for controlling routing of packets in the 5G system via the ME-platform.

Note that the necessary resource of the VDO application described in Workflow/Application[@url=‘VDO-url’]/ResourceDescription in the workflow description is referred to in the VDO activation phase starting from the workflow manager 62.

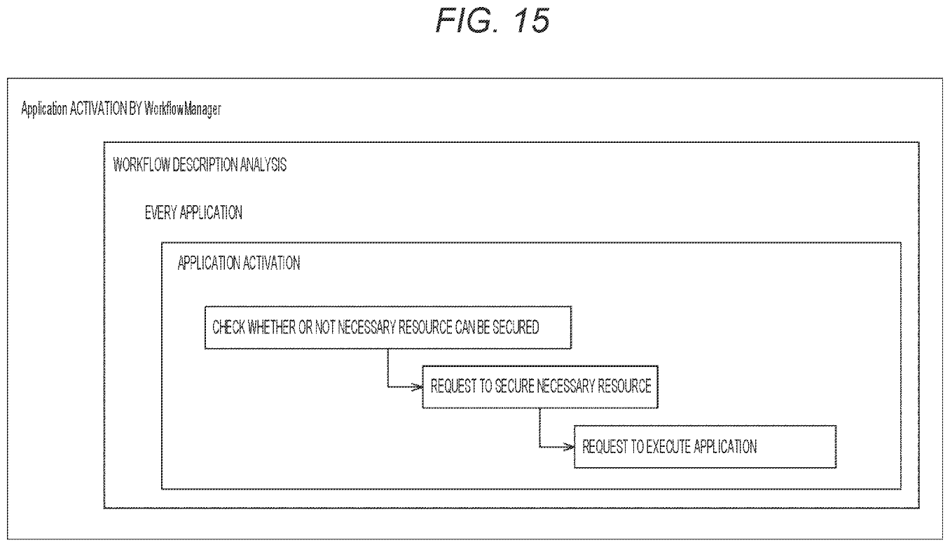

For example, as illustrated in FIG. 15, the ME-platform 83 which receives a VDO activation request from the workflow manager 62 checks whether or not the resource requirement described in the resource description are satisfied on its own ME-host 31. Then, in a case where the resource requirement described in the resource description can be satisfied, the ME-platform 83 executes a new VDO application to generate an application instance, and returns the address of the instance to the workflow manager 62.

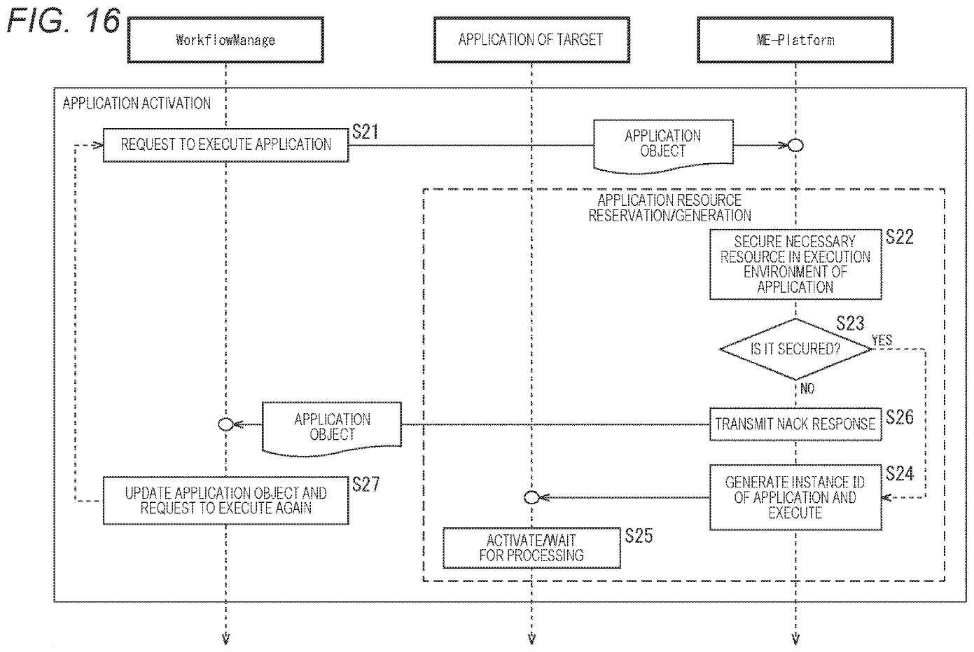

The application activation processing will be described with reference to FIG. 16.

In step S21, the workflow manager 62 generates an application object in accordance with the application definition described in the workflow description, and requests the ME-platform 83 to execute the application. Therefore, the ME-platform 83 receives the application object transmitted from the workflow manager 62. Here, in the resource requirement of the application object, for example, a necessary resource requirement described in the resource description of the workflow description is stored.

In step S22, before executing the application, the ME-platform 83 attempts to secure various resources, such as calculation resources, memory/storage, and network resources, necessary for execution of the application on the basis of the contents of the application object.

In step S23, the ME-platform 83 determines whether or not the necessary resource is secured, and in a case where it is determined that the necessary resource is secured, the processing proceeds to step S24.

In step S24, the ME-platform 83 generates an instance ID of the application object and activates the application. Then, in step S25, the application to be activated is activated and waits for processing.

On the other hand, in step S26, in a case where the ME-platform 83 determines that the necessary resource is not secured, the processing proceeds to step S26. In step S26, the ME-platform 83 NACK-responds the application object in which the resource securement fails to the workflow manager. Therefore, the workflow manager 62 receives the application object transmitted from the ME-platform 83.

Here, in a case where a plurality of candidate resource requirements is described in the resource description, in step S27, the workflow manager 62 rewrites the resource requirement part of the application object and requests the ME-platform 83 to execute the application again. Then, the processing returns to step S21, the rewritten application object is transmitted, and hereafter, until the time limit set by using this as a deadline is reached, the similar processing is repeated. Note that in a case where the time limit is exceeded, the application fails to be activated.

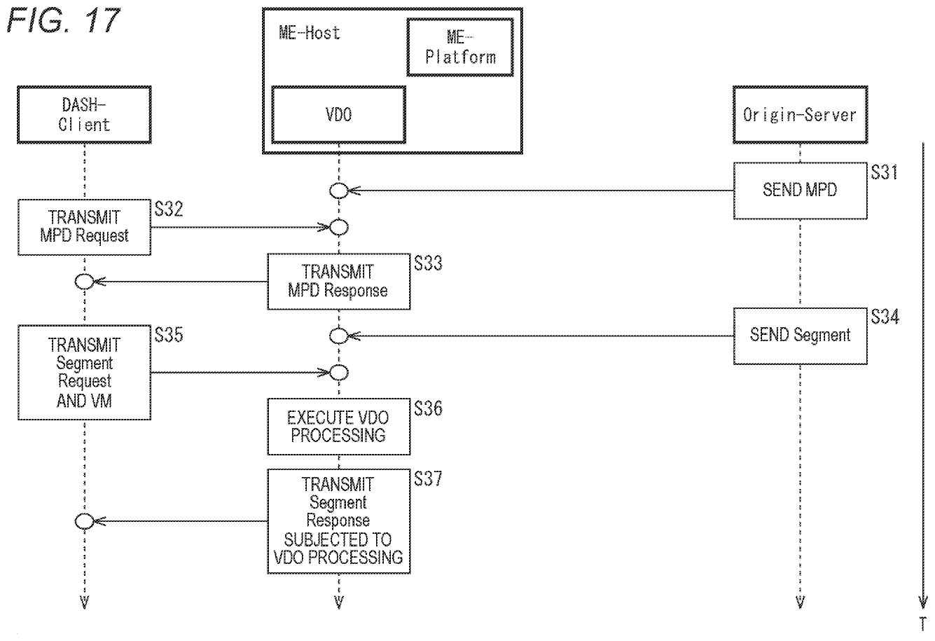

A process of giving notification of view metrics from the DASH-client 21 and generating a VDO segment in the VDO 41 will be described with reference to FIG. 17.

In step S31, the origin-server 32 sends the MPD to the VDO 41. Therefore, the VDO 41 receives the MPD.

In step S32, the DASH-client 21 transmits an MPD request to the VDO 41. Therefore, the VDO 41 receives the MPD request.

In step S33, the VDO 41 transmits, to the DASH-client 21, an MPD response to the MPD request transmitted in step S32. Therefore, the DASH-client 21 receives the MPD response.

In step S34, the origin-server 32 sends the segment to the VDO 41. Therefore, the VDO 41 receives the segment.

In step S35, the DASH-client 21 attaches the VM to a segment request and transmits the segment request to the VDO 41. Therefore, the VDO 41 receives the segment request and the VM.

In step S36, the VDO 41 executes the VDO processing on the target segment distributed from the origin-server 32 in step S34 on the basis of the VM transmitted accompanying the segment request in step S35, and generates a VDO segment (the DASH-segment subjected to the VDO processing).

In step S37, the VDO 41 returns the VDO segment subjected to the VDO processing to the DASH-client 21 as a response to the segment request.

As described above, the information processing system 11 can distribute the segments from the origin-server 32 to the VDO 41 by multicast, perform the VDO processing by the VDO 41 of the ME-host 31 which is an edge server, and transmit the VDO segment to the DASH-client 21.

<Second Information Processing Example of Information Processing System>

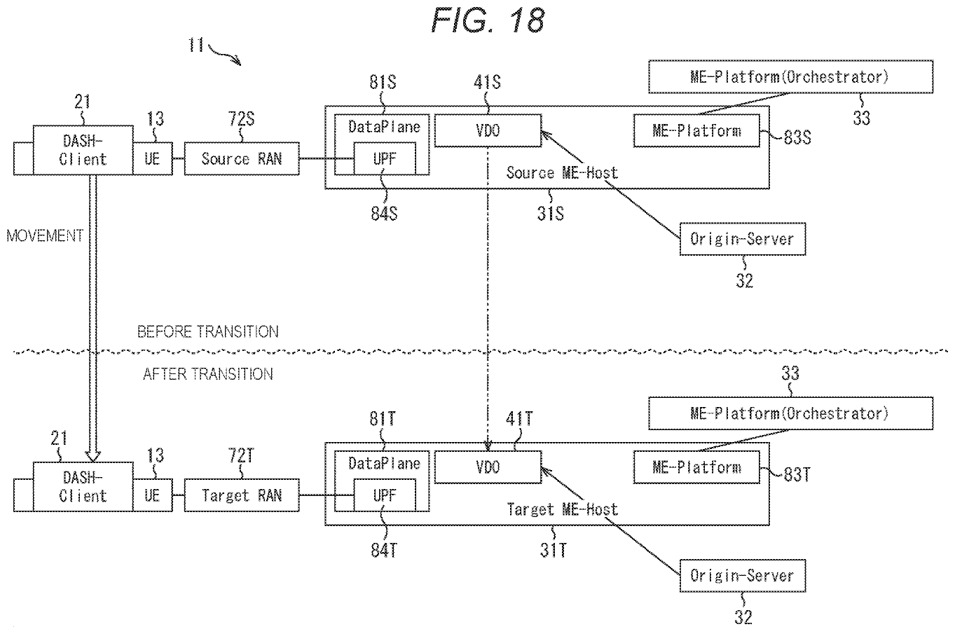

As a second information processing example of the information processing system 11, a process of synchronously duplicating the process of the VDO 41 between the ME-hosts 31 along with the inter-base station handover of the DASH-client 21 will be described with reference to FIGS. 18 to 23. For example, the second information processing example of the information processing system 11 has a characteristic that when the environment of the ME-host 31 changes due to the inter-base station handover of the DASH-client 21, a CPU for operating the VDO 41, a storage area, an IO throughput, and the like are reserved on the ME-host 31 of the transition destination, and the processing state of the VDO 41 before the transition is synchronously duplicated with respect to the VDO 41 on the ME-host 31 of the transition destination.

For example, as illustrated in FIG. 18, when the user terminal 13 in which the DASH-client 21 is mounted moves, an inter-base station handover occurs across the base stations in which the ME-hosts 31 are mounted. Hereinafter, the access network 72 before the handover is referred to as a source RAN 72S, and the ME-host 31 before the handover is referred to as a source ME-host 313. Similarly, the access network 72 as a handover destination is referred to as a target RAN 72T, and the ME-host 31 as a handover destination is referred to as a target ME-host 31T.

Then, the user terminal 13 which mounts the DASH-client 21 streaming from the VDO application on the source ME-host 31S bound to the source RAN 72S of a certain base station via the source RAN 72S moves onto the target ME-host 31T of another base station to which the target ME-host 31T is bound. Due to the inter-base station handover accompanying this movement, the VDO 41S of the source ME-host 31S transitions to the VDO 41T of the source ME-host 31T as indicated by the two-dot chain line arrow in FIG. 18.

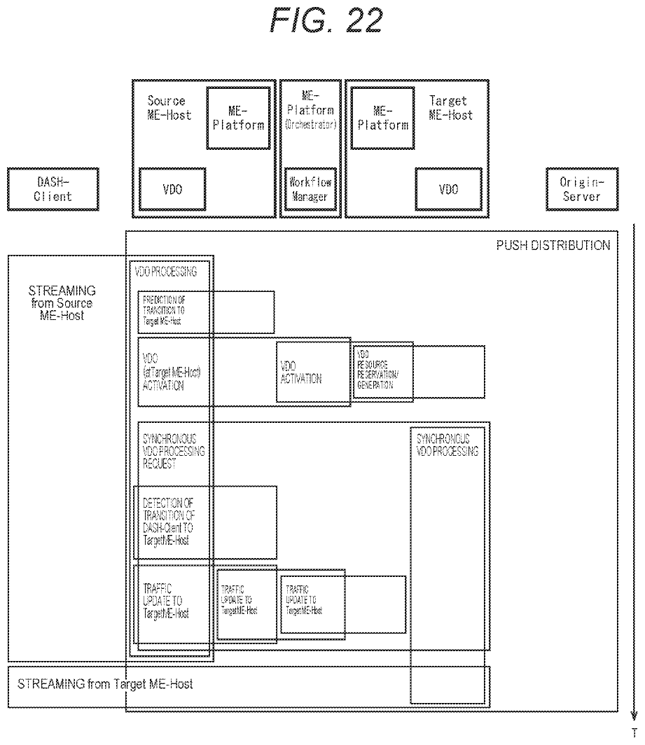

The process performed at this time will be described with reference to a flow of FIG. 22. Note that the flow of FIG. 22 illustrates a process after the streaming is already started between the DASH-client 21 and the VDO 41S.

That is, the DASH-client 21 mounted on the user terminal 13 on the source RAN 72S already performs streaming on the basis of the stream file subjected to the VDO processing from the VDO 41S on the source ME-host 31S (the streaming from the source ME-host in FIG. 22).

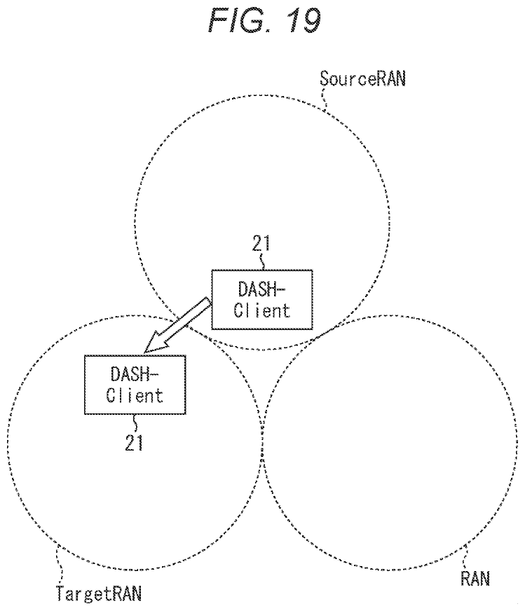

Here, as illustrated in FIG. 19, it is assumed that the user terminal 13 which mounts the DASH-client 21 moves on the target RAN 72T of the base station to which the target ME-host 31T different from the source ME-host 31S is bound.

Furthermore, the VDO 41S executed on the source ME-host 31S can detect the movement (position) of the user terminal 13 on which the DASH-client 21 is mounted by the API provided by a ME-platform 83S. Then, it is assumed from position transition information, an analysis of a mobility pattern using statistical information and AI, and the like one by one that the user terminal 13 is predicted to move from the currently existing source RAN 72S to another target RAN 72T (the prediction of the transition to the target ME-host in FIG. 22).

Then, the VDO 41S on the source ME-host 31S requests the ME-platform (orchestrator) 33 to execute the VDO 41T on the target ME-host 31T (VDO activation in FIG. 22). That is, before the DASH-client 21 transitions to the target RAN 72T, the corresponding VDO application is separately generated on the target ME-host 31T, and the execution state of the application is duplicated.

In response, a ME-platform 83T of the target ME-host 31T attempts to reserve and execute resources on the basis of protocol resource requirements equivalent to the currently established streaming session between the DASH-client 21 and the VDO 41 (VDO resource reservation/generation in FIG. 22).

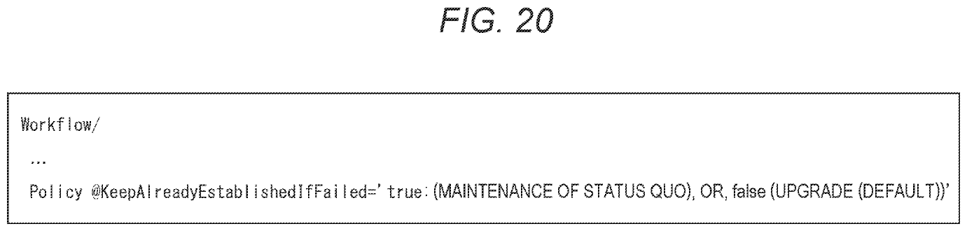

Here, policies such as maintaining a session currently established with the DASH-client 21, continuing a service with lower (or improved) quality than the session currently established in anticipation of the traffic of the transition destination cell and the load status of the ME-platform 83T, and maintaining a session with the VDO 41S on the source ME-host 31S currently established with the DASH-client 21 in a case where the quality needs to be lowered are based on the specification by ‘the session update policy at the time of handover’ described in the workflow description as illustrated in FIG. 20.

For example, in the case of KeepAlreadyEstablishedIfFailed=‘false’, the default of Workflow/Policy@KeepAlreadyEstablishedIfFailed is false, and in a case where this attribute is not described, it always indicates upgrading (for example, increasing the streaming quality) if possible and downgrading (for example, decreasing the streaming quality) if necessary. Note that a process in a case where a change occurs in the MEC environment due to the handover or the like will be described in a third information processing example.

Furthermore, in the VDO 41T on the target ME-host 31T, the necessary resource is reserved and activated (VDO resource reservation/generation in FIG. 22), but the streaming processing to the DASH-client 21 does not start immediately. For example, the VDO 41T receives a synchronous VDO processing request for requesting synchronous VDO processing from the VDO 41S on the source ME-host 31S, and performs the VDO processing in synchronization with the VDO 41S on the source ME-host 31S.

It is assumed that after a further lapse of time, the VDO 41S on the source ME-host 31S detects that the user terminal 13 on which the DASH-client 21 is mounted moves via the ME-platform 83S and is newly connected to the target RAN 72T to which the target ME-host 31T is bound (the detection of the transition of the DASH-client to the target ME-host in FIG. 22).

In response to this, a traffic change is performed so that the VDO 41T on the target ME-host 31T can receive the streaming request from the target RAN 72T after the transition (traffic update to the target ME-host in FIG. 22). At the same time, a traffic change is performed so that a response from the VDO 41T on the target ME-host 31T reaches the user terminal 13.

Therefore, the VDO 41T on the target ME-host 31T starts streaming to the DASH-client 21 after the movement via the target RAN 72T (the streaming from the target ME-host in FIG. 22).

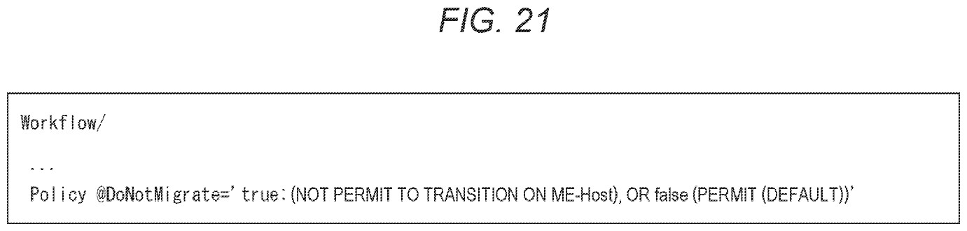

Note that, as illustrated in FIG. 21, in the workflow description, it is possible to specify whether or not to permit the transition itself between the ME-hosts 31 of the VDO application. For example, in a case where the transition itself between the ME-hosts 31 of the VDO application is not permitted, Policy@DoNotMigrate=‘true’ is specified. On the other hand, in a case where the transition of the ME-host 31 is attempted, Policy@DoNotMigrate=‘false’ is specified, which is set to a default rather than taking advantage of the MEC as much as possible. Of course, in the case of Policy@DoNotMigrate=‘true’, KeepAlreadyEstablishedIfFailed illustrated in FIG. 20 is ignored.

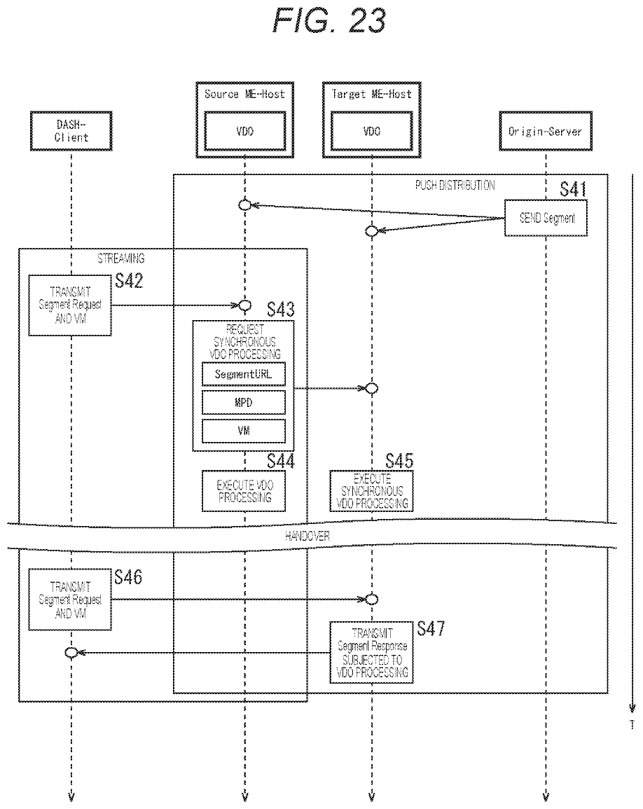

FIG. 23 is a flowchart for explaining VDO transition processing by the inter-base station handover.

In step S41, the origin-server 32 sends segments to the VDO 41S and the VDO 41T. Therefore, the VDO 41S and the VDO 41T receive the segments.

In step S42, the DASH-client 21 attaches the VM to the segment request and transmits the segment request to the VDO 41S. Therefore, the VDO 41S receives the segment request and the VM.

In step S43, the VDO 41S sends the segment URL, the MPD, and the VM to the VDO 41T, and requests synchronous VDO processing. Therefore, the VDO 41T receives the segment URL, the MPD, and the VM.

In step S44, the VDO 41S executes VDO processing to generate a VDO segment, and in step S45, the VDO 41T executes the synchronous VDO processing to generate a VDO segment.

Thereafter, when the handover occurs, in step S46, the DASH-client 21 attaches the VM to the segment request and transmits the segment request to the VDO 41T. Therefore, the VDO 41T receives the segment request and the VM.

In step S47, the VDO 41T returns the VDO segment subjected to the VDO processing in step S45 to the DASH-client 21 as a response to the segment request.

As described above, in the information processing system 11, the VDO segment can be transmitted seamlessly to the DASH-client 21 by synchronously duplicating the VDO processing of the VDO 41 between the ME-hosts 31 along with the inter-base station handover of the DASH-client 21.

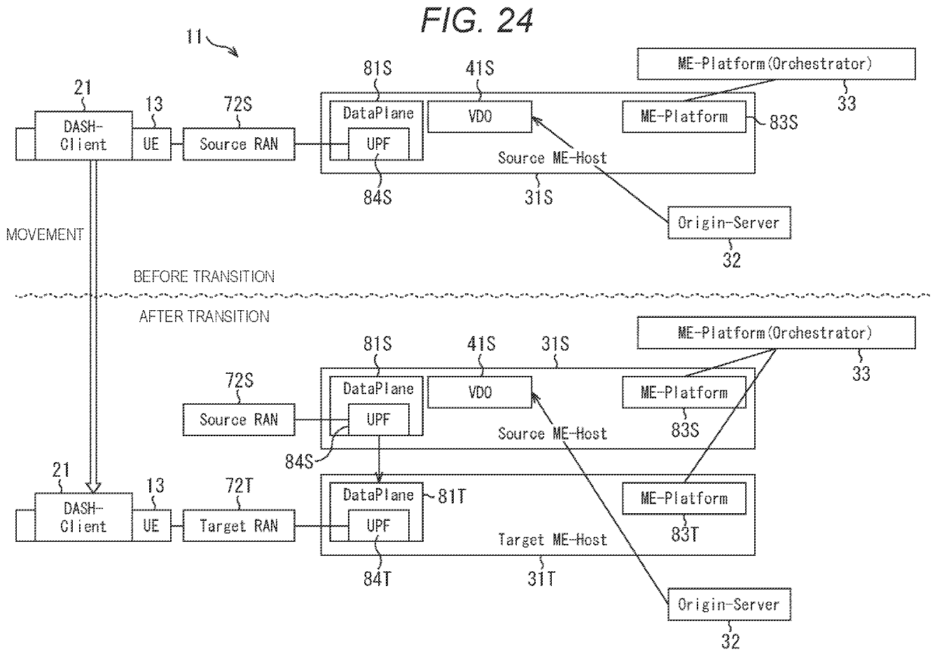

A process in a case where the VDO 41 cannot be activated on the ME-host 31 serving as the transition destination due to a resource shortage will be described with reference to FIGS. 24 to 26.

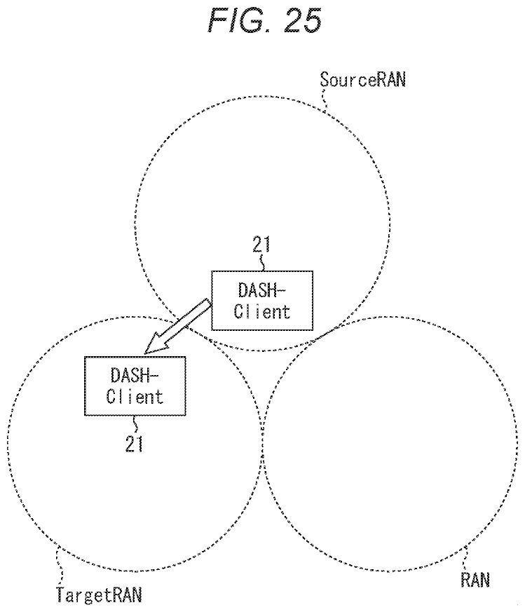

FIG. 24 illustrates states before and after the transition accompanying the occurrence of the inter-base station handover due to the movement of the DASH-client 21 from the source RAN 72S to the target RAN 72T (see FIG. 25).

That is, the user terminal 13 which mounts the DASH-client 21 streaming from the VDO application on the source ME-host 31S bound to the source RAN 72S of a certain base station via the source RAN 72S moves onto the target ME-host 31T of another base station to which the target ME-host 31T is bound. The VDO 41S of the source ME-host 31S is attempted to transition due to the inter-base station handover accompanying this movement, but the VDO 41T of the source ME-host 31T may not be activated due to a resource shortage.

In this case, while the VDO 41S of the source ME-host 31S is maintained, the VDO 41S can transmit the segment received from the origin-server 32 from the data plane 813 to the data plane 81T and transmit the segment to the DASH-client 21 via the target RAN 72T.

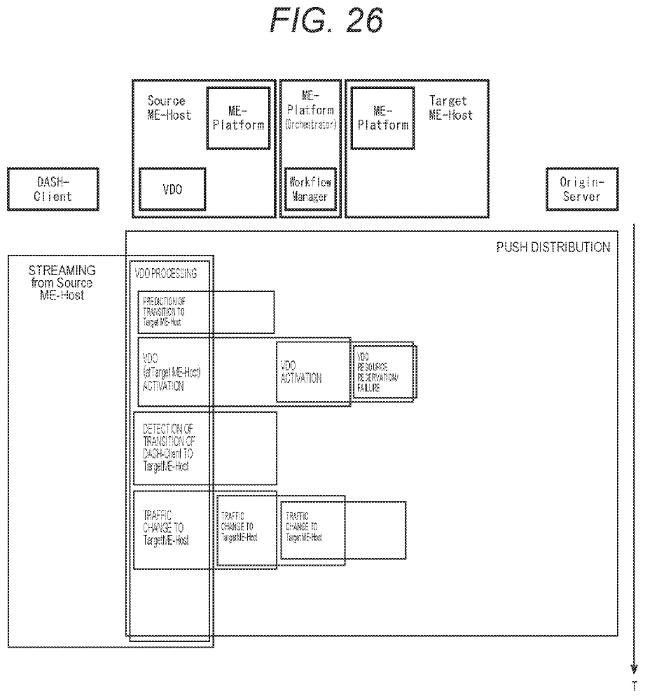

The process performed at this time will be described with reference to the flow of FIG. 26. Note that, in the flow of FIG. 26, a process after streaming is already started between the DASH-client 21 and the VDO 41S is illustrated.

First, as described above with reference to the flow of FIG. 22, the VDO 41S predicts that the user terminal 13 moves from the currently existing source RAN 72S to another target RAN 72T (prediction of transition to target ME-host in FIG. 26).

Then, the VDO 41S on the source ME-host 31S requests the workflow manager 62 of the ME-platform (orchestrator) 33 to execute the VDO 41T on the target ME-host 31T (the VDO (at the target ME-host) activation in FIG. 26).

In response, the ME-platform 83T of the target ME-host 31T attempts resource reservation and execution on the basis of protocol resource requirements equivalent to the currently established session between the DASH-client 21 and the VDO 41S. However, in this case, the activation of the VDO 41T fails.

It is assumed that after a further lapse of time, the VDO 41S on the source ME-host 31S detects that the user terminal 13 on which the DASH-client 21 is mounted moves via the ME-platform 83S and is newly connected to the target RAN 72T to which the target ME-host 31T is bound (the detection of the transition of the DASH-client to the target ME-host in FIG. 26).

In this case, the VDO 41S performs a traffic change so that the VDO 41S on the source ME-host 31S can receive the streaming request from the target RAN 72T after the transition (traffic change to the source ME-host in FIG. 26). At the same time, a traffic change to the source ME-host 31S is performed on the ME-platform 83T on the target ME-host 31T.

Therefore, even in a case where the activation of the VDO 41T on the target ME-host 31T fails, the streaming to the DASH-client 21 can be realized via the target RAN 72T while the VDO 41S on the source ME-host 31S is maintained.

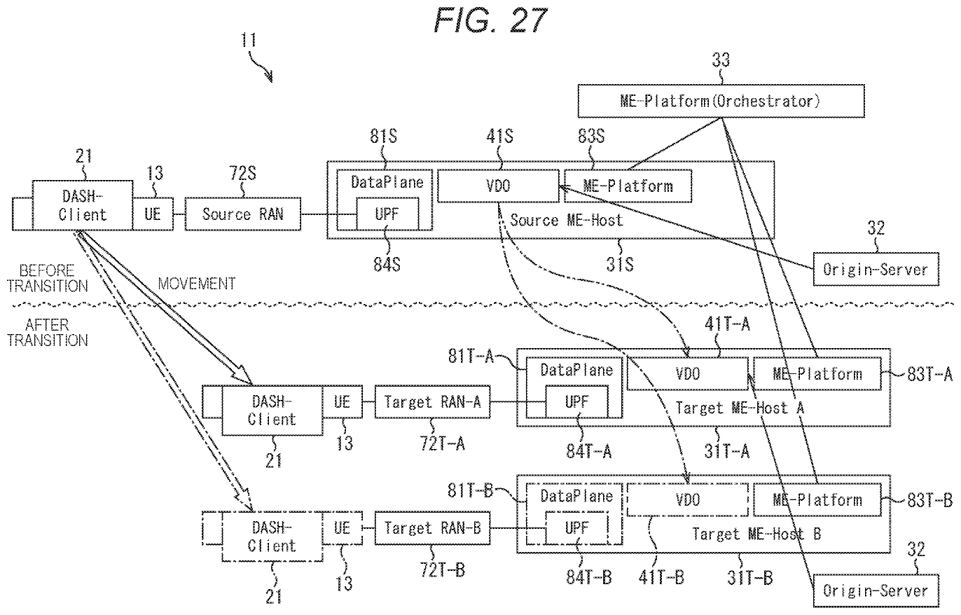

A process of executing the VDO 41T in each of a target ME-host 31T-A and a target ME-host 31T-B bound to two cells (a target RAN 72T-A and a target RAN 72T-B) for which the transition is expected in a case where the transition destination cell (RAN 72) cannot be predicted will be described with reference to FIGS. 27 to 29. Here, a case is illustrated in which the DASH-client 21 finally transitions to the target RAN 72T-A bound to target ME-host 31T-A.

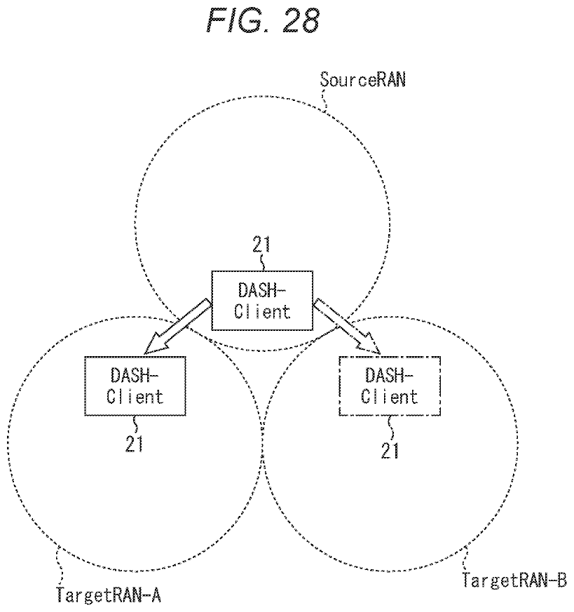

For example, FIG. 27 illustrates a state accompanying the occurrence of the inter-base station handover due to the movement of the DASH-client 21 from the source RAN 72S to the target RAN 72T-A (see FIG. 28).

That is, in a case where the DASH-client 21 cannot predict which one of the target RAN 72T-A and the target RAN 72T-B the transition is made to, a VDO 41T-A is activated in the target ME-host 31T-A, and a VDO 41T-B is activated in the target ME-host 31T-B. Then, when the transition of the DASH-client 21 to the target RAN 72T-A is detected, the streaming from the VDO 41T-A to the DASH-client 21 via the target RAN 72T-A is performed.

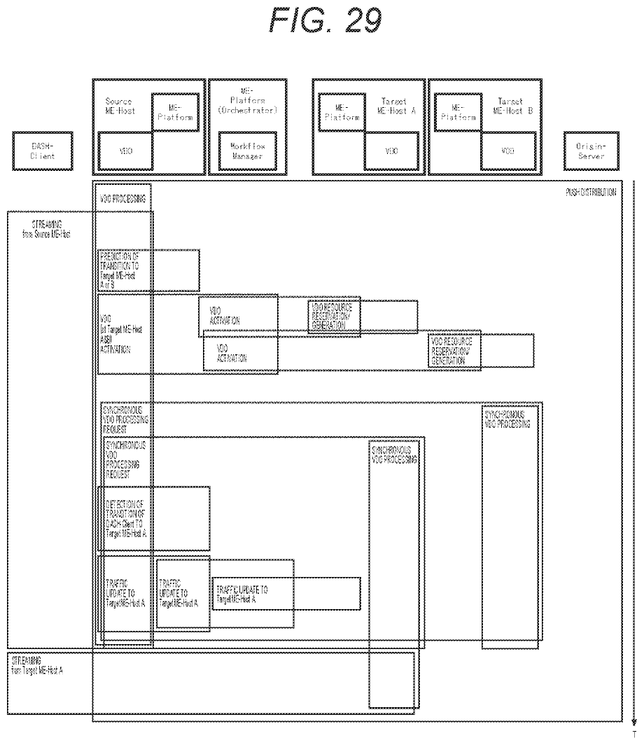

The process performed at this time will be described with reference to the flow of FIG. 29. Note that, in the flow of FIG. 29, a process after streaming is already started between the DASH-client 21 and the VDO 41S is illustrated.

First, as described above with reference to the flow of FIG. 22, the VDO 41S predicts that the user terminal 13 moves from the currently existing source RAN 72S to another target RAN 72T-A or target RAN 72T-B (the prediction of the transition to the target ME-host A or B in FIG. 29). That is, in this case, it is not possible to predict which one of the target RAN 72T-A and the target RAN 72T-B the user terminal moves to.

Then, the VDO 41S on the source ME-host 31S requests the workflow manager 62 of the ME-platform (orchestrator) 33 to execute the VDO 41T-A on the target ME-host 31T-A and execute the VDO 41T-B on the target ME-host 31T-B (the VDO (at the target ME-host A&B) activation in FIG. 29).

In response, the ME-platform 83T of the target ME-host 31T attempts resource reservation and execution on the basis of protocol resource requirements equivalent to the currently established session between the DASH-client 21 and the VDO 41S. Therefore, in the VDO 41T-A on the target ME-host 31T-A, the necessary resource is reserved and activated (VDO resource reservation/generation in FIG. 29). Similarly, in the VDO 41T-B on the target ME-host 31T-B, the necessary resource is reserved and activated (VDO resource reservation/generation in FIG. 29).

Thereafter, the ME-platform 83T of the target ME-host 31T requests synchronous VDO processing to the VDO 41T-A on the target ME-host 31T-A and requests synchronous VDO processing to the VDO 41T-B on the target ME-host 31T-B. Therefore, the VDO 41T-A and the VDO 41T-B can perform the VDO processing in synchronization with the VDO 41S on the source ME-host 31S.

It is assumed that after a further lapse of time, the VDO 41S on the source ME-host 31S detects that the user terminal 13 on which the DASH-client 21 is mounted moves via the ME-platform 83S and is newly connected to the target RAN 72T-A to which the target ME-host 31T-A is bound (the detection of the transition of the DASH-client to the target ME-host A in FIG. 29).

In response to this, a traffic change is performed so that the VDO 41T-A on the target ME-host 31T-A can receive the streaming request from the target RAN 72T-A after the transition (traffic update to the target ME-host A in FIG. 29). At the same time, a traffic change is performed so that a response from the VDO 41T-A on the target ME-host 31T-A reaches the user terminal 13.

Thereafter, the VDO 41T-A on the target ME-host 31T-A starts streaming to the DASH-client 21 after the movement via the target RAN 72T-A (streaming from target ME-host A in FIG. 29). At that time, the synchronous VDO processing of the VDO 41T-A on the target ME-host 31T-A is continued, and the synchronous VDO processing of the VDO 41T-B on the target ME-host 31T-B is ended.

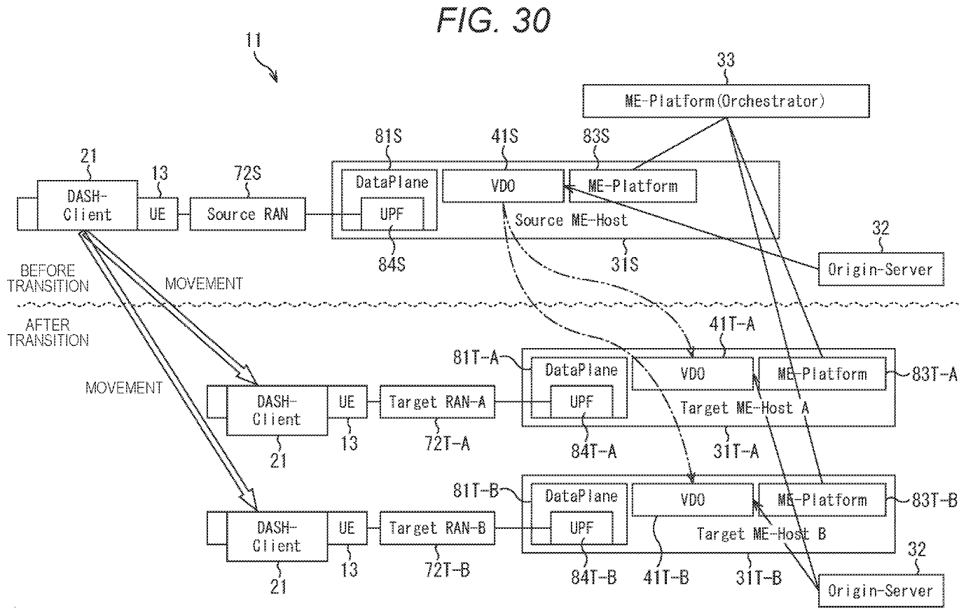

A process of securing a fault tolerance redundancy will be described with reference to FIGS. 30 to 33. Here, an example is illustrated in which the VDO 41T is executed in each of the target ME-host 31T-A and target ME-host 31T-B bound to two cells (the target RAN 72T-A and the target RAN 72T-B) having overlapping coverage, and two streaming sessions are executed in synchronization. Note that it is assumed that the DASH-client 21 after the transition is simultaneously connected to both of the target RAN 72T-A and the target RAN 72T-B.

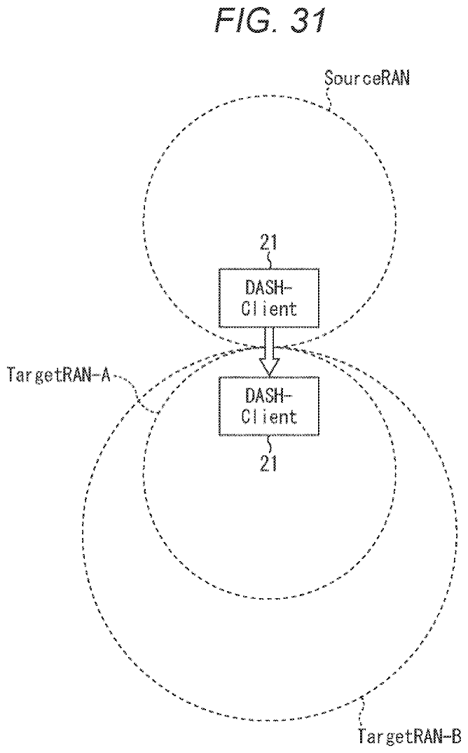

For example, FIG. 30 illustrates a state accompanying the occurrence of the inter-base station handover due to the movement of the DASH-client 21 from the source RAN 72S to the target RAN 72T-A and target RAN 72T-B (see FIG. 31).

That is, in a case where the coverages of the target RAN 72T-A and the target RAN 72T-B overlap, the VDO 41T-A is activated in the target ME-host 31T-A, and the VDO 41T-B is activated in the target ME-host 31T-B. Then, when the transition of the DASH-client 21 to the target RAN 72T-A and the target RAN 72T-B is detected, the streaming is performed to the DASH-client 21 from the VDO 41T-A via the target RAN 72T-A and from the VDO 41T-B via the target RAN 72T-B.

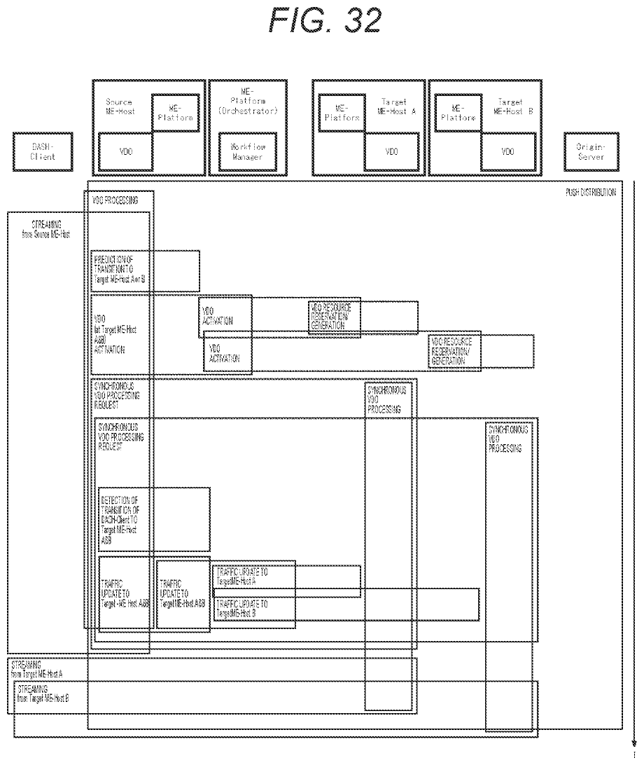

The process performed at this time will be described with reference to the flow of FIG. 32. Note that the flow of FIG. 32 illustrates a process after the streaming is already started between the DASH-client 21 and the VDO 41S.

First, as described above with reference to the flow of FIG. 22, the VDO 41S predicts that the user terminal 13 moves from the currently existing source RAN 72S to another target RAN 72T-A or target RAN 72T-B (the prediction of the transition to the target ME-host A or B in FIG. 32).

Then, the VDO 41S on the source ME-host 31S requests the workflow manager 62 of the ME-platform (orchestrator) 33 to execute the VDO 41T-A on the target ME-host 31T-A and execute the VDO 41T-B on the target ME-host 31T-B (the VDO (at the target ME-host A&B) activation in FIG. 32).

In response, the ME-platform 83T of the target ME-host 31T attempts resource reservation and execution on the basis of protocol resource requirements equivalent to the currently established session between the DASH-client 21 and the VDO 41S. Therefore, in the VDO 41T-A on the target ME-host 31T-A, the necessary resource is reserved and activated (VDO resource reservation/generation in FIG. 32). Similarly, in the VDO 41T-B on the target ME-host 31T-B, the necessary resource is reserved and activated (VDO resource reservation/generation in FIG. 26).

Thereafter, the ME-platform 83T of the target ME-host 31T requests synchronous VDO processing to the VDO 41T-A on the target ME-host 31T-A and requests synchronous VDO processing to the VDO 41T-B on the target ME-host 31T-B. Therefore, the VDO 41T-A and the VDO 41T-B can perform the VDO processing in synchronization with the VDO 41S on the source ME-host 31S.

It is assumed that after a further lapse of time, the VDO 41S on the source ME-host 31S detects that the user terminal 13 on which the DASH-client 21 is mounted moves via the ME-platform 83S and is newly connected to the target RAN 72T-A to which the target ME-host 31T-A is bound and the target RAN 72T-B to which the target ME-host 31T-B is bound (the detection of the transition of the DASH-client to the target ME-host A&B in FIG. 32).

In response to this, a traffic change is performed so that the VDO 41T-A on the target ME-host 31T-A can receive the streaming request from the target RAN 72T-A after the transition (traffic update to the target ME-host A in FIG. 32). At the same time, a traffic change is performed so that a response from the VDO 41T-A on the target ME-host 31T-A reaches the user terminal 13.

Similarly, a traffic change is performed so that the VDO 41T-B on the target ME-host 31T-B can receive the streaming request from the target RAN 72T-B after the transition (traffic update to the target ME-host B in FIG. 26). At the same time, a traffic change is performed so that a response from the VDO 41T-B on the target ME-host 31T-B reaches the user terminal 13.

Thereafter, the VDO 41T-A on the target ME-host 31T-A starts streaming to the DASH-client 21 after the movement via the target RAN 72T-A (streaming from the target ME-host A in FIG. 32). Furthermore, the synchronous VDO processing of the VDO 41T-A on the target ME-host 31T-A is continued.

Similarly, the VDO 41T-B on the target ME-host 31T-B starts streaming to the DASH-client 21 after the movement via the target RAN 72T-B (streaming from target ME-host B in FIG. 32). Furthermore, the synchronous VDO processing of the VDO 41T-B on the target ME-host 31T-B is continued.

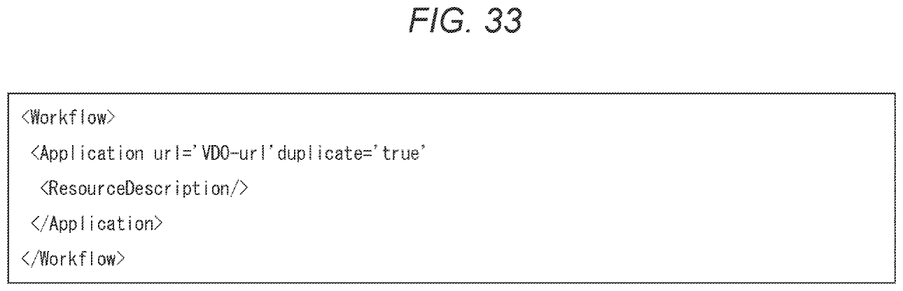

For example, as illustrated in FIG. 33, it is assumed that an instruction on this redundant configuration can be given by setting a duplicate attribute of an application element of a target application to ‘true’ in workflow description.

<Third Information Processing Example of Information Processing System>

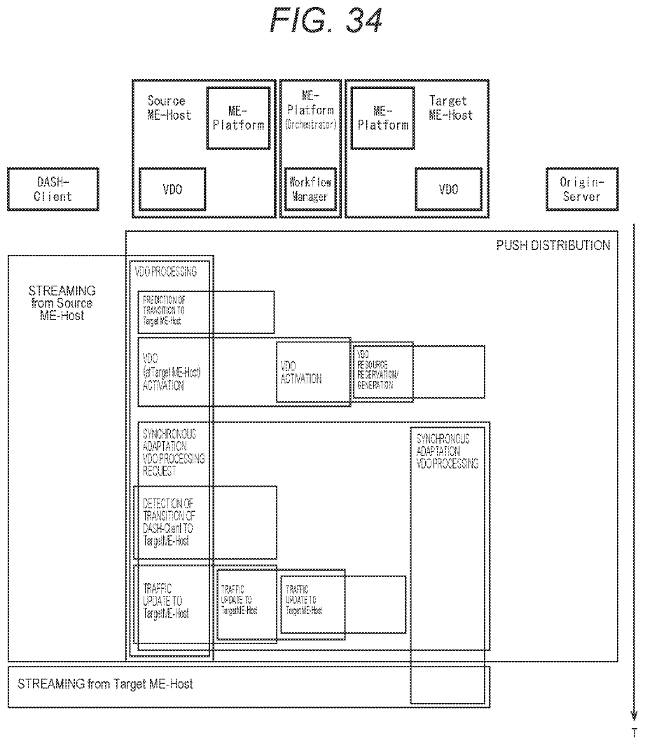

As a third information processing example of the information processing system 11, the variable duplication of the state of the VDO processing based on traffic prediction will be described with reference to FIGS. 34 to 38. For example, the third information processing example of the information processing system 11 has a characteristic that when the state of the VDO processing before the transition is synchronously duplicated with respect to the VDO 41 on the ME-host 31 of the transition destination, the stream quality is changed on the basis of the traffic prediction and the resource prediction of the ME-host 31.

For example, it is assumed that a possibility that a session resource equivalent to the session before the transition cannot be secured is detected in advance in the VDO 72T executed on the ME-host 31T bound to the target RAN 41T scheduled to transition. In this case, in anticipation of the change in the stream quality after the transition, the VDO processing (hereinafter, referred to as a synchronous adaptation VDO processing request) is performed to generate the segment of which the quality is changed. Then, in the selection of the target quality, optimization is performed within the range of the limit on the basis of the MPD or a recommended rate.

Also in this case, the synchronous VDO processing request in the processing in a case where the transition destination cell (RAN 72) cannot be predicted as described above with reference to FIG. 29, the processing for securing the fault tolerance redundancy as described above with reference to FIG. 32, and the like can be replaced with a synchronous adaptation VDO processing request.

The process performed at this time is illustrated in the flow of FIG. 34. Note that in the flow illustrated in FIG. 34, a process is performed which is similar to the flow of FIG. 22 except that the synchronous VDO processing request in the flow of FIG. 22 is replaced with the synchronous adaptation VDO processing request, and thereafter, the synchronous adaptation VDO processing is performed, and the detailed description thereof is omitted.

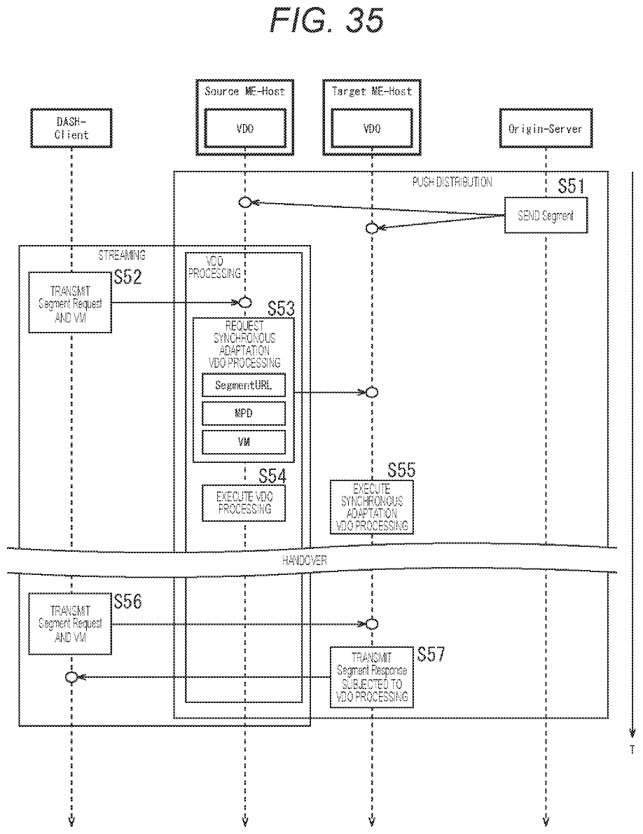

FIG. 35 is a flowchart for explaining a process of variably duplicating the state of the VDO processing based on the traffic prediction.

For example, in steps S51 and S52, processes similar to those in steps S41 and S42 in FIG. 23 are performed. Then, in step S53, the VDO 41S sends the segment URL, the MPD, and the VM to the VDO 41T, and requests the synchronous adaptation VDO processing. Therefore, the VDO 41T performs the synchronous adaptation VDO processing in step S55.

Then, in steps S54, S56, and S57, processes similar to those in steps S44, S46, and S47 in FIG. 23 are performed.

As described above, when the VDO 41T performs the synchronous adaptation VDO processing, for example, the state of the VDO processing based on the traffic prediction can be variably duplicated, and for example, streaming can be performed in anticipation of a change in the stream quality after the transition.

Here, the synchronous adaptation VDO processing request will be described.

For example, as described above, the VDO 41S on the source ME-host 31S streaming to the transition DASH-client 21 before the transition detects a possibility that the DASH-client 21 transitions to the target RAN 72T bound to the target ME-host 31T. In response to this, after the VDO 41T is activated on the target ME-host 31T, the synchronous adaptation VDO processing with respect to the VDO 41T is performed.

Then, in the synchronous adaptation VDO processing, it is assumed that the quality of the stream after the VDO processing is changed in anticipation of constraints on an appropriate streaming session assumed in a case where the DASH-client 21 transitions to the target RAN 72T in the future in view of the current traffic state in the target RAN 72T and the resource states of calculation, storage, or the like in the target ME-host 31T.

Furthermore, there is a possibility that the session resource currently established in the source ME-host 31S is not secured depending on the current traffic of the target RAN 72T and the resource states of calculation, storage, or the like, or the traffic predicted in the future after the transition of the DASH-client 21 and the resource states of calculation, storage, or the like. Therefore, in a case where the environment is poorer than the current environment, the VDO processing is performed such that a segment of a representation with less resource consumption (for example, a lower bit rate) is generated among representations of the adaptation set currently being reproduced. Note that the representation is selected from a representation group in a certain adaptation set in some cases, or the adaptation set itself is changed in other cases. In this way, for example, a segment having different stream quality (a higher bit rate or a lower bit rate) can be adaptively selected on the basis of the traffic prediction of the transition destination.

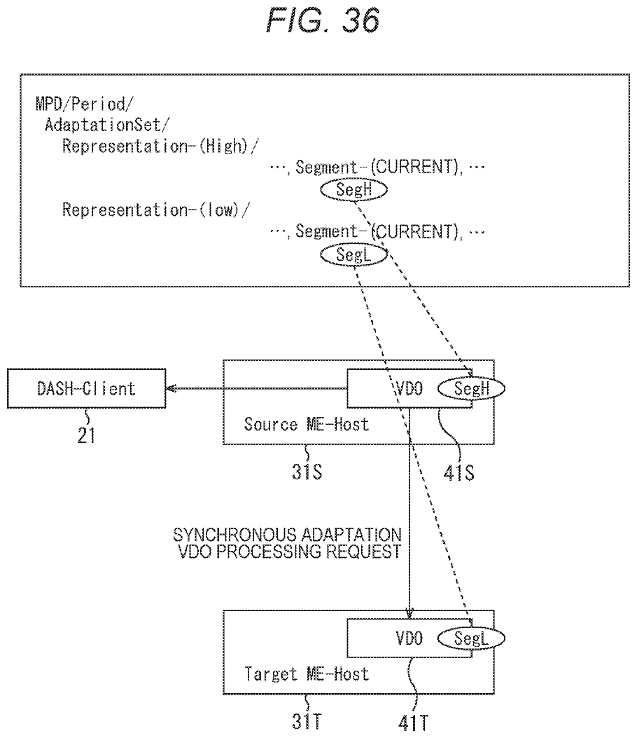

FIG. 36 illustrates a flow of segments when the VDO processing is performed with such a synchronous adaptation VDO processing request as a trigger.

For example, as illustrated, it is assumed that the representation serving as a reproduction target in the VDO 41S of the source ME-host 31S is representation-(High), and the representation having an attribute optimum for the current or future resource state in the target ME-host 31T is representation-(low).

Then, using the synchronous adaptation VDO processing request as a trigger, the VDO processing is started on the basis of the segment of the different representation of the same adaptation set in the same time section as the segment currently being reproduced. That is, in the VDO 41S, the VDO processing is performed on a segment SegH having a higher bit rate, whereas in the VDO 41T, the VDO processing is performed on a segment SegL having a lower bit rate in accordance with the synchronous adaptation VDO processing request. Note that this synchronous adaptation VDO processing request is performed when it is confirmed that a session resource different from the session resource passing through the current source ME-host 31S is secured in the environment passing through the target ME-host 31T.

Hereinafter, the messaging protocol of the synchronous adaptation VDO processing request will be described.

For example, the messaging protocol of the synchronous adaptation VDO processing request from the VDO 41S on the source ME-host 31S before the transition to the VDO 41T on the target ME-host 31T scheduled to transition can be defined as follows.

That is, a VDO trigger request message is introduced as a message between the VDOs 41. For example, a VDO trigger request element has an adaptive VDO attribute indicating whether or not the VDO processing is adaptive, a viewportMetricsFromDASHClient attribute for storing the VM from the VDO 41S on the source ME-host 31S, and a stream element for specifying the segment of the target stream.

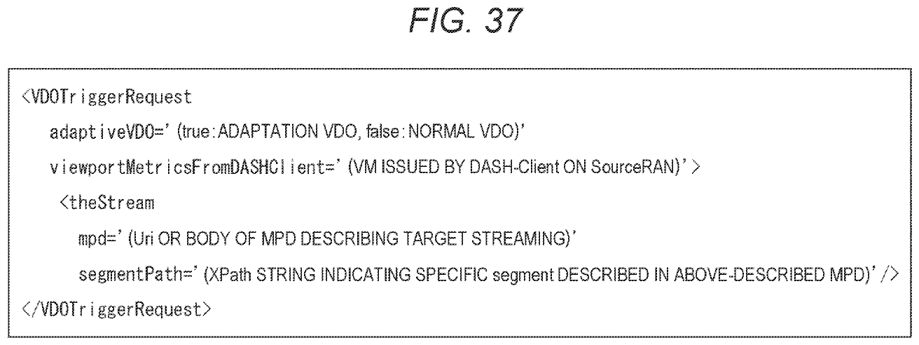

FIG. 37 illustrates an example of a structure of a VDO trigger request.

For example, the adaptive VDO attribute indicates that normal VDO processing is executed with a value of false, and conformance VDO processing is performed with a value of true.

Furthermore, the viewportMetricsFromDASHClient attribute is issued by the DASH-client 21 to the VDO 41S in step S52 of FIG. 35 described above, for example.

Furthermore, the Stream element has a reference to the MPD including the attribute of the stream to be controlled (the URL of the MPD) or an mpd attribute for storing the MPD body, and has a segment path attribute for storing an XPath string indicating a specific segment described in the MPD.

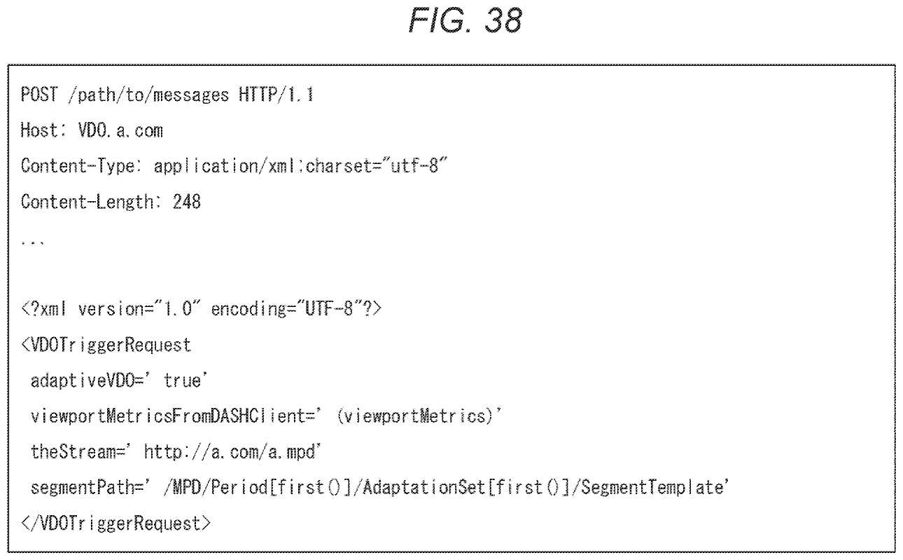

Here, the VDO trigger request message is transferred from the VDO 41S on the source ME-host 31S to the VDO 41T on the target ME-host 31T by using, for example, HTTP-POST as illustrated in FIG. 38.

For example, FIG. 38 illustrates that the segment optimized in the viewpoint direction indicated by (viewport metrics) may be changed to the quality (for example, a bit rate or the like) optimal for the environment of the ME-host 31 as the transition destination and generated with respect to the segment specified in the segment template element of the initial adaptation set element of the initial period element of the mpd specified at the URL of http://a.com/a.mpd.

<Outline of VDO Processing in Edge Server>

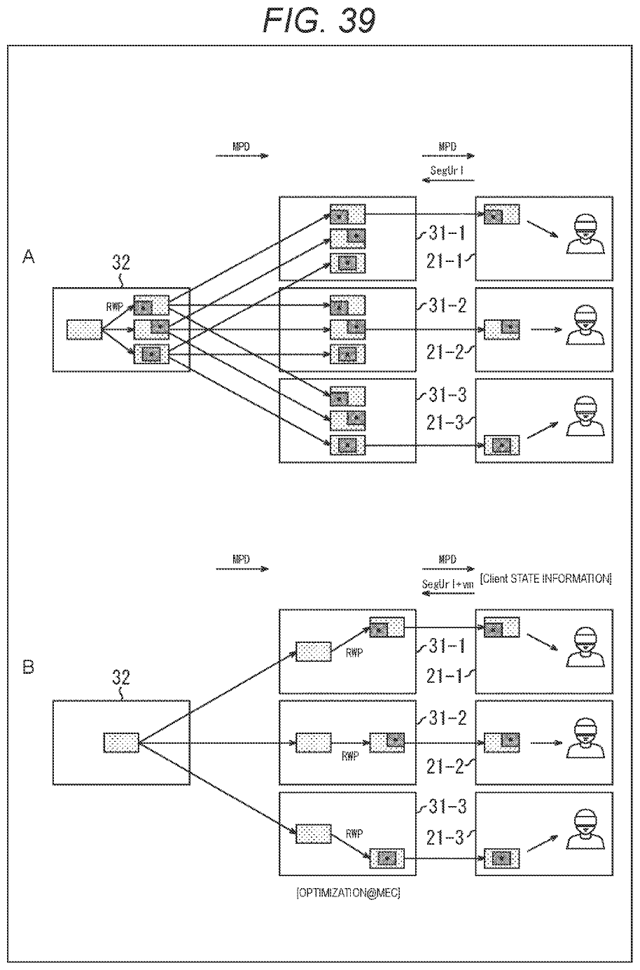

The outline of the VDO processing in the edge server will be described with reference to FIG. 39.

For example, A of FIG. 39 illustrates the outline of the VDO processing performed in the conventional information processing system, and B of FIG. 39 illustrates the outline of the VDO processing performed in the ME-host 31 which is the edge server in the information processing system 11 of this embodiment.

For example, in the conventional information processing system, the DASH-segment generated by region wise packing (RWP) in the origin-server 32 is multicast to the ME-hosts 31-1 to 31-3. Then, the DASH-segment appropriate for each state of the DASH-clients 21-1 to 21-3 is selected on the basis of the MPD, and the DASH-segment is acquired from the ME-hosts 31-1 to 31-3 on the basis of each segment URL.

On the other hand, in the information processing system 11, the DASH-segment is multicast from the origin-server 32 to the ME-hosts 31-1 to 31-3. Then, the segment appropriate for the state of each of the DASH-clients 21-1 to 21-3 is selected on the basis of the MPD, and the RWP is performed in each of the ME-hosts 31-1 to 31-3 on the basis of the segment URL and the VM. Therefore, the DASH-segments optimized for the viewport for every DASH-clients 21-1 to 21-3 can be generated in the ME-hosts 31-1 to 31-3 and acquired by the DASH-clients 21-1 to 21-3, respectively.

Therefore, in the information processing system 11, by performing distribution processing on the VR streaming in the ME-hosts 31-1 to 31-3, it is possible to avoid concentration of a load or occurrence of a delay in the origin-server 32.

<Configuration Example of Computer>

Next, the above-described series of processing (information processing method) can be performed by hardware or software. In a case where the series of processing is performed by software, a program configuring the software is installed in a general-purpose computer or the like.

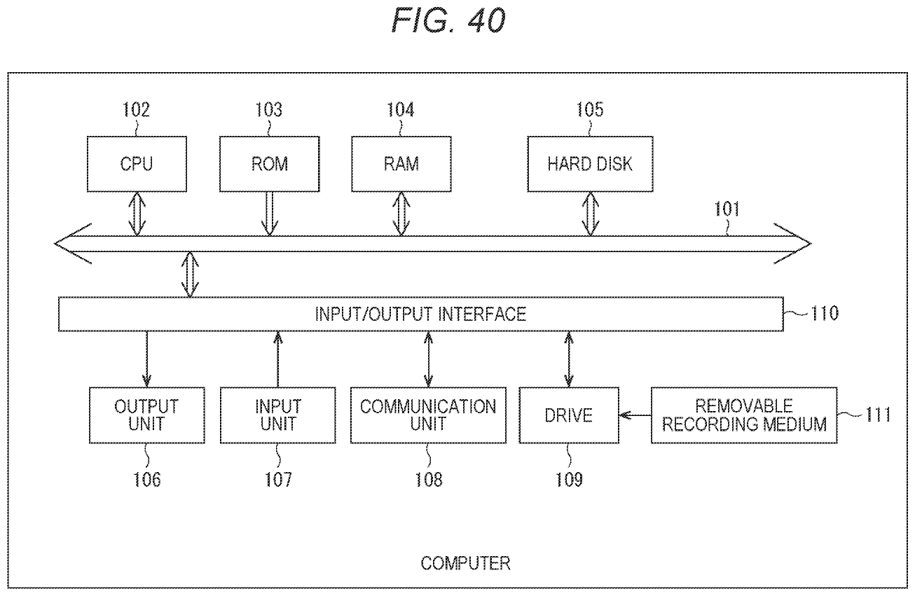

FIG. 40 is a block diagram illustrating a configuration example of an embodiment of a computer in which a program for executing the above-described series of processing is installed.

The program can be recorded in advance in a hard disk 105 or a ROM 103 as a recording medium built in the computer.

Alternatively, the program can be stored (recorded) in a removable recording medium 111 driven by a drive 109. Such a removable recording medium 111 can be provided as so-called package software. Here, examples of the removable recording medium 111 include a flexible disk, a compact disc read only memory (CD-ROM), a magneto optical (MO) disk, a digital versatile disc (DVD), a magnetic disk, and a semiconductor memory.

Note that the program can be installed in the computer from the removable recording medium 111 as described above, or can be downloaded to the computer via a communication network or a broadcast network and installed in the built-in hard disk 105. That is, for example, the program can be wirelessly transferred from a download site to the computer via an artificial satellite for digital satellite broadcasting, or can be transferred by wire to the computer via a network such as a local area network (LAN) or the Internet.

The computer incorporates a central processing unit (CPU) 102, and an input/output interface 110 is connected to the CPU 102 via a bus 101.

When a command is input by a user operating an input unit 107 or the like via the input/output interface 110, the CPU 102 executes a program stored in the read only memory (ROM) 103 according to the command. Alternatively, the CPU 102 loads the program stored in the hard disk 105 into a random access memory (RAM) 104 and executes the program.

Therefore, the CPU 102 performs the processing according to the above-described flowchart or the processing performed by the configuration of the above-described block diagram. Then, for example, the CPU 102 outputs the processing result from an output unit 106 via the input/output interface 110 or transmits the processing result from a communication unit 108 and further records the processing result in the hard disk 105 as necessary.

Note that the input unit 107 includes a keyboard, a mouse, a microphone, and the like. Furthermore, the output unit 106 includes a liquid crystal display (LCD), a speaker, and the like.

Here, in this specification, the processing performed by the computer according to the program is not necessarily performed in time series in the order described as the flowchart. That is, the processing performed by the computer according to the program also includes processing executed in parallel or individually (for example, parallel processing or processing by an object).

Furthermore, the program may be processed by one computer (processor) or may be processed in a distributed manner by a plurality of computers. Moreover, the program may be transferred to a remote computer and executed.

Moreover, in this specification, the system means an aggregation of a plurality of components (devices, modules (parts), and the like), and it does not matter whether or not all the components are in the same housing. Therefore, both a plurality of devices which is housed in separate housings and connected via a network and one device in which a plurality of modules is housed in one housing are systems.

Furthermore, for example, a configuration described as one device (or a processing unit) may be divided to include a plurality of devices (or processing units). Conversely, configurations described above as a plurality of devices (or processing units) may be collectively configured as one device (or a processing unit). Furthermore, a configuration other than the above-described configuration may be added to the configuration of each device (or each processing unit). Moreover, as long as the configuration and operation of the entire system are substantially the same, a part of the configuration of a certain device (or a processing unit) may be included in the configuration of another device (or another processing unit).

Furthermore, for example, the present technology can be configured as cloud computing in which one function is shared by a plurality of devices via a network and jointly processed.

Furthermore, for example, the above-described program can be executed in an arbitrary device. In that case, it is sufficient if the device has a necessary function (functional block or the like) and can obtain necessary information.

Furthermore, for example, each step described in the above-described flowcharts can be executed by one device or shared by a plurality of devices. Moreover, in a case where one step includes a plurality of processes, the plurality of processes included in the one step can be executed by one device or shared by a plurality of devices. In other words, a plurality of processes included in one step can also be executed as processes of a plurality of steps. Conversely, the processes described as a plurality of steps can be collectively executed as one step.

Note that, in the program executed by the computer, processing of steps describing the program may be executed in time series in the order described in this specification or may be executed in parallel or individually at necessary timing such as when a call is made. That is, as long as there is no contradiction, the processing of each step may be executed in an order different from the above-described order. Moreover, the processing of steps describing this program may be executed in parallel with the processing of another program, or may be executed in combination with the processing of another program.

Note that a plurality of the present technologies described in this specification can be implemented independently as long as there is no contradiction. Of course, a plurality of arbitrary present technologies can be implemented in combination. For example, some or all of the present technology described in any of the embodiments can be implemented in combination with some or all of the present technology described in other embodiments. Furthermore, some or all of the above-described arbitrary present technology can be implemented in combination with other technologies not described above.

<Combination Example of Configuration>

Note that the present technology can also have the following configurations.

(1)

An information processing apparatus including:

an optimization processing unit that generates an optimization segment from contents multicast from a distribution server by performing optimization processing on a segment corresponding to a request by a client terminal according to a viewpoint direction in the client terminal; and

a transmission unit that transmits the optimization segment to the client terminal.

(2)

The information processing apparatus according to (1), in which

the transmission unit streams the contents to the client terminal via a first network, the apparatus further including:

a synchronous optimization processing request unit that requests another information processing apparatus which streams the contents to the client terminal via the second network to perform optimization processing synchronized with the optimization processing unit in response to a handover from the first network to the second network occurring due to movement of the client terminal.

(3)

The information processing apparatus according to (2), in which

the synchronous optimization processing request unit sends information for specifying the segment, media presentation description (MPD) which is a file describing metadata of the contents, and viewpoint direction information indicating a viewpoint direction in the client terminal to the another information processing apparatus, and performs control to duplicate a processing state in the optimization processing unit.

(4)

The information processing apparatus according to (3), in which

the viewpoint direction information is attached to the request of the segment and is transmitted from the client terminal.

(5)

The information processing apparatus according to (4), in which

the client terminal notifies the optimization processing unit of the viewpoint direction information by using a URL parameter defined in MPEG-dynamic adaptive streaming over HTTP (DASH).

(6)

The information processing apparatus according to any one of (2) to (5), in which

the synchronous optimization processing request unit changes a stream quality of the contents before and after the handover when requesting the another information processing apparatus to perform the optimization processing.

(7)

The information processing apparatus according to (6), in which

the synchronous optimization processing request unit changes the stream quality of the contents on the basis of traffic prediction in a network after the handover or resource prediction of the another information processing apparatus.

(8)

An information processing method for an information processing apparatus including:

generating an optimization segment from contents multicast from a distribution server by performing optimization processing on a segment corresponding to a request by a client terminal according to a viewpoint direction in the client terminal; and

transmitting the optimization segment to the client terminal.

(9)

A program for causing a computer of an information processing apparatus to execute information processing including:

generating an optimization segment from contents multicast from a distribution server by performing optimization processing on a segment corresponding to a request by a client terminal according to a viewpoint direction in the client terminal; and

transmitting the optimization segment to the client terminal.

Note that this embodiment is not limited to the above-described embodiments, and various modifications can be made without departing from the scope of the present disclosure. Furthermore, the effects described in this specification are merely examples and are not limited, and other effects may be provided.

### REFERENCE SIGNS LIST

11 Information processing system
12 Cloud
13 User terminal
21 DASH-client
31 ME-host
32 Origin-server
33 ME-platform (orchestrator)
41 VDO
42 Database holding unit
43 Storage unit
61 Database holding unit
62 Workflow manager
71 5G core network system
72 Access network
81 Data plane
82 Application
83 ME-platform
84 UPF

1. An information processing apparatus comprising:
an optimization processing unit that generates an optimization segment from contents multicast from a distribution server by performing optimization processing on a segment corresponding to a request by a client terminal according to a viewpoint direction in the client terminal; and
a transmission unit that transmits the optimization segment to the client terminal.

2. The information processing apparatus according to claim 1, wherein
the transmission unit streams the contents to the client terminal via a first network, the apparatus further comprising:
a synchronous optimization processing request unit that requests another information processing apparatus which streams the contents to the client terminal via the second network to perform optimization processing synchronized with the optimization processing unit in response to a handover from the first network to the second network occurring due to movement of the client terminal.

3. The information processing apparatus according to claim 2, wherein
the synchronous optimization processing request unit sends information for specifying the segment, media presentation description (MPD) which is a file describing metadata of the contents, and viewpoint direction information indicating a viewpoint direction in the client terminal to the another information processing apparatus, and performs control to duplicate a processing state in the optimization processing unit.

4. The information processing apparatus according to claim 3, wherein
the viewpoint direction information is attached to the request of the segment and is transmitted from the client terminal.

5. The information processing apparatus according to claim 4, wherein
the client terminal notifies the optimization processing unit of the viewpoint direction information by using a URL parameter defined in MPEG-dynamic adaptive streaming over HTTP (DASH).

6. The information processing apparatus according to claim 2, wherein
the synchronous optimization processing request unit changes a stream quality of the contents before and after the handover when requesting the another information processing apparatus to perform the optimization processing.

7. The information processing apparatus according to claim 6, wherein
the synchronous optimization processing request unit changes the stream quality of the contents on a basis of traffic prediction in a network after the handover or resource prediction of the another information processing apparatus.

8. An information processing method for an information processing apparatus comprising:
generating an optimization segment from contents multicast from a distribution server by performing optimization processing on a segment corresponding to a request by a client terminal according to a viewpoint direction in the client terminal; and
transmitting the optimization segment to the client terminal.

9. A program for causing a computer of an information processing apparatus to execute information processing comprising:
generating an optimization segment from contents multicast from a distribution server by performing optimization processing on a segment corresponding to a request by a client terminal according to a viewpoint direction in the client terminal; and
transmitting the optimization segment to the client terminal.
